(19) United States
(12) Patent Application Publication
(10) Pub. No.: US 2020/0410392 A1
(43) Pub. Date: Dec. 31, 2020

(54) TASK-AWARE COMMAND RECOMMENDATION AND PROACTIVE HELP

(71) Applicant: Adobe Inc., San Jose, CA (US)

(72) Inventors: Gaurav Verma, Bengaluru (IN); Iftikhar Ahamath Burhanuddin, Bengaluru (IN); Harvineet Singh, Ludhiana (IN); Bhanu Prakash Reddy Guda, Prakasam (IN); Aadhavan Nambhi M, Erode (IN); Aarsh Prakash Agarwal, Lucknow (IN)

(21) Appl. No.: 16/454,683

(22) Filed: Jun. 27, 2019

(51) Int. Cl. G06N 20/00; G06F 9/451; G06N 7/00

(52) U.S. Cl. CPC G06N 20/00; G06N 7/005; G06F 9/453

(57) ABSTRACT

A task-aware command recommendation system and related techniques are described herein. The task-aware command recommendation system can provide a user of a software application (e.g., an analytics application or other software application) with guidance by predicting commands that can be executed to accomplish a given task. For example, an ongoing task being performed by a user can be determined based on commands that have been performed by the user up to a current point in time. Information about the task can be incorporated into one or more command recommendation models, which can determine one or more commands to recommend to the user for performing the task. In some cases, the task-aware command recommendation system can include a help prediction model that can anticipate when the user is having difficulties completing a task, and can provide help for the user to continue performing the task.

### FIELD

This application is related to providing task-aware command recommendations and proactive help for software applications.

### BACKGROUND

Software applications have become commonplace tools in computing systems. One example of a software application includes a data analytics software application. Powered by sophisticated computational techniques and powerful software tools, data analytics has experienced a tremendous advancement in recent history. Data analytics software applications (also referred to herein as “analytics applications”) have become an integral part of the decision-making process of analysts. An analytics application provides an essential tool that can liberate users from tedious data processing tasks and that can allow users to focus on issues demanding more sophisticated human intelligence. For example, an analyst can interact with an analytics application (e.g., Tableau™, Microsoft Power BI™, Adobe Analytics™, among others) to dissect and visualize data, and to integrate results into various decision-making processes.

Interacting with analytics applications can be difficult, due in part to such applications having complex command sequences that must be executed to perform a variety of tasks. Users of such software interfaces face challenges due to insufficient product and domain knowledge, and oftentimes find themselves in need of help. For example, while querying data to create reports or building machine learning models, analysts can face software-related problems, which are further amplified by lack of support and in-person training. The workflows that are involved in such analytics applications often include complex sequences of commands, and keeping track of the commands can be difficult.

Many other software applications also have complex sequences commands that need to be executed to perform various tasks. Based on the complexities of software applications that include numerous commands and associated tasks, there is a need for systems and techniques that provide task-aware command recommendations and proactive help for users.

### SUMMARY

A task-aware command recommendation system and related techniques are described herein. The task-aware command recommendation system provides a user of a software application with guidance by predicting commands that can be executed to accomplish a given task. One illustrative example of a software application that will be used herein is an analytics application. For instance, examples of services provided by analytics applications include, but are not limited to, real-time web analytics, advanced user segmentation, audience segmentation, predictive marketing, among others. While an analytics application is used as an illustrative example herein, the techniques described herein can apply to any type of software application that includes commands that need to be executed to perform one or more tasks. As used herein, commands are low level interactions (e.g., selecting a dimension, sorting a column, a drag-and-drop operation, among others) with a user interface of a software application. A sequence of commands can be aimed at achieving a given task of the software application. A session is a collection of tasks performed by a user in one visit (e.g., from log-in to log-out of the software application). In one given session of an application, many tasks can be accomplished by a user.

The task-aware command recommendation system can use topic modeling techniques to identify an ongoing task being performed by a user. For example, a topic model can be trained in an unsupervised manner to identify the ongoing task using commands performed by the user. The topic model can include a bi-term topic model (BTM), or other suitable model. Information about the task can be incorporated into one or more command recommendation models, which can determine one or more commands to recommend to the user for performing the task. For example, using the identified task and the commands performed by the user, the task-aware command recommendation system can predict one or more commands that a user would likely need to execute for the identified task. A command recommendation model can include a machine learning system, such as a recurrent neural network (RNN).

In some implementations, the task-aware command recommendation system can include a help prediction model. The help prediction model provides an intelligent interface that can anticipate when the user is having difficulties completing a task, and can provide help for the user to continue performing the task. For example, the help prediction model can include a binary classification machine learning system that uses the commands performed by the user and timing information to detect if a user is in need of help. The timing information can indicate an amount of time that has passed since a last command was performed by the user. If a user is determined to need help, the help prediction model can proactively provide the aforementioned command recommendations and/or other information that can help the user complete one or more tasks.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following drawing:

FIG. 1 is a block diagram illustrating an example of a task-aware command recommendation system, in accordance with some examples provided herein;

FIG. 2A is a diagram illustrating an example of tasks of an analytics application and sequences of commands associated with the tasks, in accordance with some examples provided herein;

FIG. 2B is a diagram illustrating an example of topics of a document and words associated with the topics, in accordance with some examples provided herein;

FIG. 3 is a schematic diagram illustrating an example of a probabilistic suffix tree (PST), in accordance with some examples provided herein;

FIG. 4A is a schematic diagram illustrating an example of a PST incorporating task information, in accordance with some examples provided herein;

FIG. 4B is a schematic diagram illustrating another example of a PST incorporating task information, in accordance with some examples provided herein;

FIG. 5 is a diagram illustrating an example of a Recurrent Neural Network (RNN) of a command recommendation engine, in accordance with some examples provided herein;

FIG. 6 is a diagram illustrating an example of an (RNN) of a command recommendation engine that uses task information, in accordance with some examples provided herein;

FIG. 7 is a diagram illustrating an example of an RNN of a command recommendation engine that predicts task information and commands, in accordance with some examples provided herein;

FIG. 8 is a diagram illustrating an example of a random forest classifier of a help modeling engine, in accordance with some examples provided herein;

FIG. 9 is a diagram illustrating an example of a Long Short-Term Memory (LSTM) classifier of a help modeling engine, in accordance with some examples provided herein;

FIG. 10 is an image illustrating an example of a graphical user interface (GUI) of a command recommendation system, in accordance with some examples provided herein;

FIG. 11A, FIG. 11B, and FIG. 11C are diagrams including images illustrating aspects of a GUI of an analytics application with a command recommendation system, in accordance with some examples provided herein;

FIG. 12 is a diagram including images illustrating additional aspects of the GUI shown in FIG. 11 providing proactive help, in accordance with some examples provided herein;

FIG. 13 is a flowchart illustrating an example of a process of determining one or more recommended commands, in accordance with some examples provided herein;

FIG. 14 is a block diagram illustrating an example implementation of the process shown in FIG. 13, in accordance with some examples provided herein; and

FIG. 15 is an example computing device architecture of an example computing device that can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

A software application is a program, or group of programs, designed for use by an end user of a computing device, such as a mobile device, a computer, a tablet, or other computing device. For example, a software application can include programs such as data analytics programs, database programs, word processors, Web browsers, spreadsheets, among others.

A user can carry out several sequences of commands while interacting with a graphical user interface (GUI) of a software application in a given session. As used herein, a command is the lowest level of interaction that a user can have with the GUI of an application. Using an analytics application as an example, illustrative examples of commands include selecting a dimension, sorting a column, a drag-and-drop operation, among many others. Each of these sequences of commands within a session is associated with a larger task that the user (e.g., an analyst) is trying to achieve. As used herein, a session is a collection of tasks performed by a user in one or more visits, and a task is an intermediate goal that a user aims to achieve through a sequence (or series) of commands. Illustrative examples of tasks of an analytics application include building a segment, building a visualization of certain data (e.g., a chart, a plot, and/or other visualization), among others. In one example, a task can be building of a segment. An instance of the segment can include website visits where a home page was visited as part of the visit. Once created, this segment can be applied to a report to filter the data. Accordingly, commands are low level interactions with the GUI of an application, and a sequence of such commands can be aimed at achieving a task. A session can include the collection of tasks performed by a user in one visit (e.g., between the time a user logs into an analytics application and the time a user logs out of the analytics application). In one given session, many tasks can be completed by a user.

As noted above, one example of a software application is a data analytics software application (referred to herein as an “analytics application”). Sophisticated computational techniques and powerful software tools have led to advancements in data analytics. Users can interact with analytics applications to parse and visualize data, and can integrate the results into their decision-making processes. In many applications, analytics applications have become an essential tool that can free users from certain data processing tasks, allowing the users to focus on issues demanding more sophisticated human intelligence. Analytics applications can provide various services, such as real-time web analytics, predictive marketing, and advanced user segmentation. In one illustrative example, a web analytics application can be used to track, report, and analyze web traffic. Examples of analytics applications include Tableau™, Microsoft Power BI™, Adobe Analytics™, Google Analytics™, among others. For example, Tableau™ and Power BI™ are business-focused analytics services that aim to provide interactive data visualizations to facilitate a better user interaction.

Users of software applications can face a multitude of problems. The problems can arise based on various issues, such as a software application having complex command sequences that must be executed to perform a variety of tasks, insufficient product and/or domain knowledge, GUI related issues, lack of support, lack of proper training, among others. Users can oftentimes find themselves in need of help when such problems arise. For instance, using a data analytics application as an example, while querying data to create reports or building machine learning models (e.g., for user segmentation in the domain of website behavior analysis), analysts can face software-related problems, which can be further amplified by lack of support and in-person training. In another example, the workflows that are involved in certain software applications (e.g., analytics applications) can often include complex sequences of commands, and keeping track of which commands to perform for certain tasks can be difficult.

Given the complexity of the sequences of commands needed to perform various tasks, and the difficulty in keeping track of the sequences, a task-aware command recommendation system and related techniques are described herein to provide proactive assistance to a user of a software application. The task-aware command recommendation system can help the user determine which commands to perform in order to continue with and complete a desired task. As described in more detail below, the task-aware command recommendation system can use topic modeling techniques to identify an ongoing task being performed by a user of a software application, and can use the task to determine one or more commands to recommend to the user for performing the task. The task-aware command recommendation system can, in some implementations, include a help prediction model that can predict when the user is having difficulties completing a task. For example, the help prediction model can use the commands performed by the user and timing information to detect if a user is in need of help. If the user is determined to need help, command recommendations and/or other information can be provided.

Examples provided below use an analytics application as an illustrative example of a software application with which the task-aware command recommendation system and related techniques described herein can be used. While an analytics application is used as an illustrative example herein, the task-aware command recommendation system and related techniques described herein can apply to any type of software application that includes commands that need to be executed to perform one or more tasks.

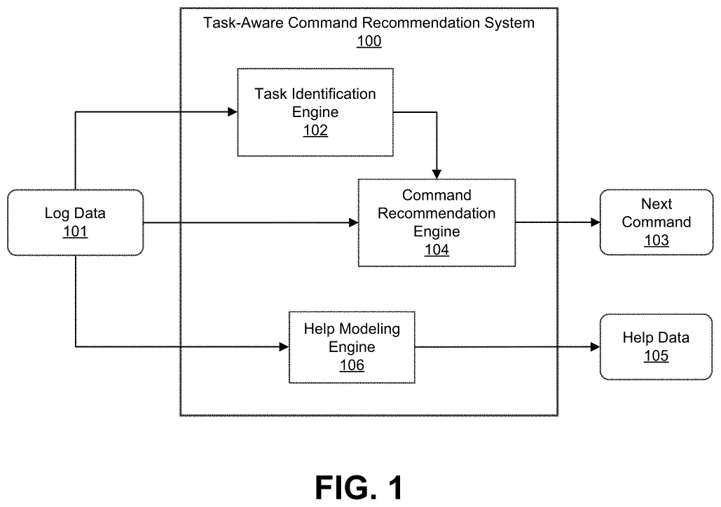

FIG. 1 is a block diagram illustrating an example of a task-aware command recommendation system 100. The task-aware command recommendation system 100 includes various components, including a task identification engine 102, a command recommendation engine 104, and a help modeling engine 106. Log data 101 is used as input to the task identification engine 102, the command recommendation engine 104, and the help modeling engine 106. The log data 101 can be used to identify tasks for a given session, predict commands for an identified task, and determine a user might need help. As described above, a command is a lowest level of interaction with a GUI of an application (e.g., an analytics application), such as selecting a dimension, sorting on a column, among others. A task of an application is an intermediate goal, such as building a segment, creating a visualization for the data, among others. A session is a collection of tasks, such as from the time of login to the time logout of an application. Each command should belong to at least one task, and each session can have multiple ongoing tasks that can be interleaved with each other. A command may belong to two different tasks. In some cases, a user cannot continue a session after logging out of the application.

The task identification engine 102 can be trained to identify the ongoing task a user is performing (or attempting to perform) for an application. The task can be identified in an unsupervised manner using topic modeling techniques (e.g., using a bi-term topic model as described in more detail below, or using another suitable modeling technique). For example, the task identification engine 102 can model task information based on the commands that have been executed so far within a current session of an application. In some cases, the task prediction for an entire session can be modeled through a machine learning system architecture (e.g., a recurrent neural network (RNN)-based architecture or other machine learning or neural network architecture). For instance, a machine learning system can take the task and the ongoing commands observed up to a current point in time as input, and can predict a final task distribution for the whole session.

The output of the task identification engine 102 can be used as input by the command recommendation engine 104. The command recommendation engine 104 can use the identified task to predict one or more commands (e.g., a next command 103) the user is likely to need to continue with the task and/or one or more commands that a user would likely execute given the task and the commands performed up to that point in time. The task information is explicitly incorporated to predict the one or more commands, which allows the system to have a broader context to base predictions on. Incorporating the task information when predicting command recommendations can filter out commands that are unrelated to the ongoing task, thus increasing the command recommendation performance. The command recommendation engine 104 can model command recommendations through a machine learning system architecture (e.g., a recurrent neural network (RNN)-based architecture or other machine learning or neural network architecture) by incorporating the task information at the input layer. In some cases, one or more predicted commands can be presented as recommended commands in a continuous manner (e.g., on a GUI of an analytics application) as the user navigates the application.

The help modeling engine 106 can identify whether the user needs help at a certain point in time. The help modeling engine 106 can use a binary classification machine learning system in some cases to determine whether or not help is needed, where a first binary class (e.g., a 1) indicates the need for help and a second binary class (e.g., a 0) indicates no help is needed. If it is determined that the user needs help, the help modeling engine 106 can output help data 105. The help data 105 can include one or more recommended commands and/or other information related to the task being performed and/or the one or more recommended commands. For example, once a user is determined to need help, the help modeling engine 106 can proactively present (e.g., on a GUI of an analytics application) the one or more command recommendations and/or other information that can help the user complete the ongoing task. In one illustrative example, in addition to or as an alternative to the recommended commands, documentation can be provided based on the command that the user is likely to need to continue with or complete the task. The help modeling engine 106 allows the task-aware command recommendation system 100 to be a proactive system that identifies the need for help automatically without manual intervention.

The components of the task-aware command recommendation system 100 can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

While the task-aware command recommendation system 100 is shown to include certain components, one of ordinary skill will appreciate that the task-aware command recommendation system 100 can include more or fewer components than those shown in FIG. 1. For example, the task-aware command recommendation system 100 can also include an input device and an output device (not shown). The task-aware command recommendation system 100 may also include, in some instances, one or more memory devices (e.g., one or more random access memory (RAM) components, read-only memory (ROM) components, cache memory components, buffer components, database components, and/or other memory devices), one or more processing devices (e.g., one or more CPUs, GPUs, and/or other processing devices) in communication with and/or electrically connected to the one or more memory devices, one or more wireless interfaces (e.g., including one or more transceivers and a baseband processor for each wireless interface) for performing wireless communications, one or more wired interfaces (e.g., a serial interface such as a universal serial bus (USB) input, a lightening connector, and/or other wired interface) for performing communications over one or more hardwired connections, and/or other components that are not shown in FIG. 1.

The task-aware command recommendation system 100 can be integrated with (e.g., integrated into the software, added as a plug-in, or otherwise integrated with) any type of application, such as an analytics application, a gaming application, a database application, among others. Examples of analytics applications include a web analytics system, a predictive marketing system, an advanced user segmentation system, or other suitable analytics application. Specific examples of analytics applications include Tableau™, Microsoft Power BI™, Adobe Analytics™, and Google Analytics™, but can include any other analytics application.

In some implementations, the task-aware command recommendation system 100 can be implemented locally by and/or included in a computing device. For example, the computing device can include a server (e.g., in a software as a service (SaaS) system or other server-based system), a personal computer, a tablet computer, a mobile device, a wearable device, and/or any other computing device with the resource capabilities to perform the techniques described herein. In some implementations, the task-aware command recommendation system 100 can include or be part of a server-based system (e.g., a cloud infrastructure system, also referred to as a cloud network) that provides server-based services to one or more client computing devices. For example, an application (e.g., mobile application, a desktop application, or other suitable device application) and/or a website associated with a provider of an analytics platform (and/or the task-aware command recommendation system 100) can be installed and/or executed by the one or more client computing devices. In such an example, the application and/or website can access (through a network) the server-based services provided by the task-aware command recommendation system 100. In another example, the server-based network can host an application, and a user can order and use the application on demand through a communications network (e.g., the Internet, a WiFi network, a cellular network, and/or using another other suitable communication network). In certain embodiments, the server-based services provided by the task-aware command recommendation system 100 can include a host of services that are made available to users of the server-based infrastructure system on demand. Services provided by the server-based infrastructure system can dynamically scale to meet the needs of its users. The server-based network can comprise one or more computers, servers, and/or systems. In some cases, the computers, servers, and/or systems that make up the server-based network are different from on-premises computers, servers, and/or systems that may be located at a site (e.g., a site including one or more computing devices, such as an enterprise location).

The task-aware command recommendation system 100 can receive log data 101 as input. In some instances, the log data 101 can be used to train one or more components of the task-aware command recommendation system 100 to perform the functions described herein. For training, the log data 101 can be split into a training set (for training the task identification engine 102, the command recommendation engine 104, and/or the help modeling engine 106) and a test set (used to test the trained models). In some cases, the training set and the test set can be split on the basis of the users. For example, twenty percent of users can be chosen for the test set, and the remaining eighty percent of the users can be chosen for the training set. Once the components of the task-aware command recommendation system 100 are trained, the log data 101 can include data indicating commands performed up to a point in time, which can be used during inference mode (when a user is using the analytics platform) to identify tasks and recommend commands, and to determine when help is needed.

In some cases, the same log data 101 can be used (e.g., during training or inference) by the task identification engine 102, the command recommendation engine 104, and the help modeling engine 106. The features may vary between the different engines, but the data on which these models are trained can remain the same. In some implementations, different data can be used (e.g., during training or inference) by the task identification engine 102, the command recommendation engine 104, and/or the help modeling engine 106.

In some examples, the log data 101 can include a product usage log made up of a sequence of commands. In one illustrative example, the log data 101 can include click stream data of an analytics application. The click stream data can be limited in some cases to include the activities or commands (e.g., in a workspace section) of the analytics application. In one illustrative example of a dataset used to train the components of the task-aware command recommendation system 100, a set of click stream data for an analytics application can include approximately 357,808 sessions, 68,890 different users, and 267 unique commands executed by the users. The average number (or length) of commands per sequence can be approximately 21 commands. This example set of data will be used throughout the application as an illustrative example to describe various features of the task-aware command recommendation system 100.

In some cases, pre-processing can be applied to the log data 101 before using the log data 101 for training the task-aware command recommendation system 100. For instance, command sequences with very little user activity can be dropped, such as commands that were logged to indicate UI events and not explicitly executed by the users. In another example, during the pre-processing, commands can be removed in instances where the same command was executed several times consecutively. For example, the number of such consecutive occurrence of commands can be limited to two. For uniformity, sequences with a number of commands (referred to as length) less than 21 can be dropped, and sequences with a length greater than 21 can be trimmed (where 21 is the average number of commands per sequence in the illustrative example from above). Each of these sequences (represented herein as S) can be used as input to the task-aware command recommendation system 100.

As noted above, the task identification engine 102 can be trained to identify the ongoing task of an application a user is performing (or attempting to perform). To be able to identify an ongoing task, sequences of commands from the log data 101 need to be identified in order to understand all possible tasks that a user can perform in a particular application (e.g., the tasks an analyst can perform in an analytics application). The tasks can be identified in an unsupervised manner using topic modeling techniques, such as plain Latent Dirichlet Allocation (LDA), bi-term topic modeling, or other topic modeling technique. For example, the task identification engine 102 can use bi-term topic modeling to extract the tasks that are possible in the application.

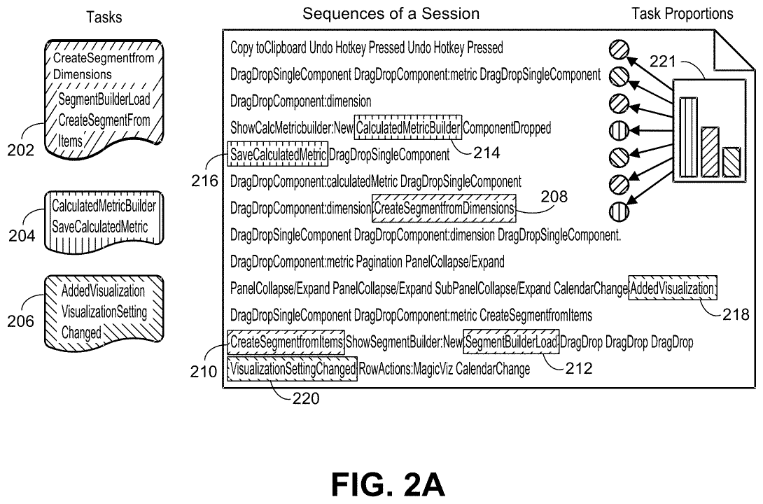

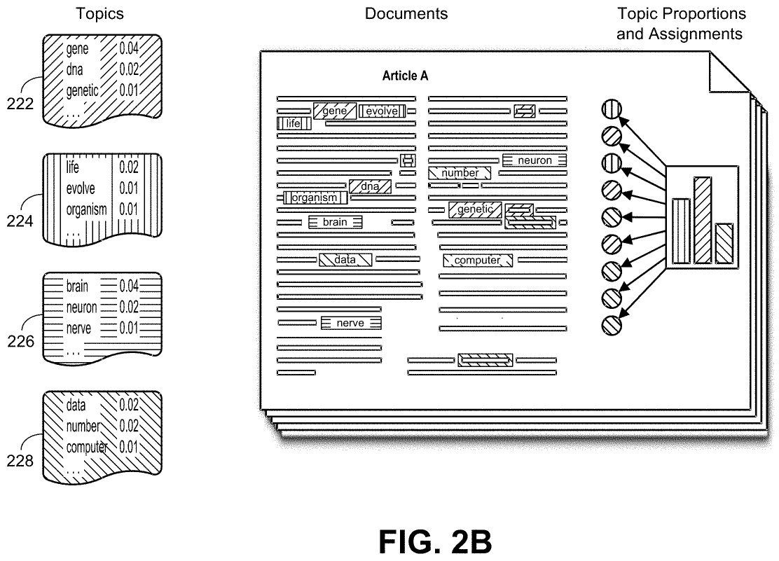

FIG. 2A is a diagram illustrating an example of tasks of an analytics application and sequences of commands associated with the tasks. The tasks include task 202, task 204, and task 206. As shown, the task 202 is associated with the command 208, the command 210, and the command 212. The task 204 is associated with the command 214 and the command 216. The task 206 is associated with the command 218 and the command 220. The task proportions 221 indicate, as per the predictions of a topic model (such as BTM), the probability of a given sequence of commands belonging to tasks identified by the topic model.

The task modeling described herein can be analogized to topic modeling. For example, each of the command sequences obtained from log data 101 can be treated as a document, and a topic model of the task identification engine 102 can be trained using the topic modeling technique, such as a bi-term topic model (BTM). FIG. 2B is a diagram illustrating an example of topics of a document and words associated with the topics. The topics include topic 222, topic 224, topic 226, and topic 228. The topic 222 is associated with words such as gene, DNA, genetic, etc. The topic 224 is associated with words such as life, evolve, organism, etc. The topic 226 is associated with words such as brain, neuron, nerve, etc. The topic 228 is associated with words such as data, number, computer, etc. Topic models can be used in the domain of text analysis to identify, in an unsupervised fashion, the topics that are present in a corpus of text documents. One such model typically used in topic modeling is the LDA. The commands used in an analytics application correspond to the words in a corpus of documents, the tasks of the analytics application correspond to the topics in the corpus, and a session of an analytics application corresponds to a document in the corpus.

As noted above, the task identification engine 102 can use bi-term topic modeling to extract the tasks that are possible in the software application. A BTM proves to be coherent with the tasks that are possible in various applications, such as various analytics applications. For example, a BTM or similar model can be used, instead of more popular approaches for topic modeling such as LDA, to alleviate the data sparsity problem. As described in more detail below, the data sparsity problem arises due to the co-occurrence matrix for each pair of commands being sparse as the command sequences are short in length. While bi-term topic modeling will be used as an example herein, one of ordinary skill will appreciate that any other topic modeling technique can be used.

As noted above, in some cases, LDA can have issues when performed on data from an application, such as an analytics application. For example, in an LDA model, while estimating the parameters, the co-occurrence of every pair of commands in the vocabulary is considered even when the session lengths are short. For example, a short session can be a session that is less than 0.1 (based on

$$\frac{session length}{vocabulary size} ) .$$

Using the example from above, the vocabulary size (corresponding to the command space in an analytics application or other software application) is 267 and the average session length is 21, which is considered a short session

$$( \frac{21}{267} < 0.1 ) .$$

In shorter contexts (session<0.1), computing a co-occurrence matrix for each and every pair of commands in the command space can be sparse, which can lead to the problem of data sparsity noted above.

Bi-term topic modeling can be used to alleviate the problem of data sparsity. For example, using a BTM, the task identification engine 102 can learn the tasks by directly modeling the generation of command co-occurrence patterns (i.e. biterms) in the whole corpus of sessions. The corpus can include all the sequences of commands in a session (e.g., analogous to a document with each new line as a sequence of commands, where the document is the “corpus”). The whole corpus can be considered as a mixture of tasks (or topics), where each biterm is drawn from a specific task independently. The probability that a biterm drawn from a specific task is further captured by the chances that both words in the biterm are drawn from the topic. For example, using bi-term topic modeling, a topic assignment of each biterm can be sampled from a conditional distribution of each biterm, and topic assignment counters can be updated. After sufficient sampling is performed, BTM model parameters can be computed using the topic assignment counters for a biterm topic. The co-occurrence patterns of commands across all the sequences of commands are used to learn a common model (which is used as the task model that can determine a task distribution for a sequence of commands, as described in more detail below). An advantage of using bi-term topic modeling is that a BTM explicitly models the command co-occurrence patterns to enhance the task learning. The BTM also uses the aggregated patterns in the whole corpus for learning tasks, solving the problem of sparse command co-occurrence patterns at the session-level.

In some examples, an input parameter while training the BTM of the task identification engine 102 is the number of topics K. If K is too small, each topic may contain more than one task, and if K is too large, there may be overlapping topics. The BTM of the task identification engine 102 can be fit for various K values, such as K=5, 7, 10, 14, 17, 20, and an optimal K value can be selected. A value of K=14 will be used as an illustrative example herein, in which case a 14-dimensional vector (each dimension include one topic of the 14 topics) can be generated. The K-dimensional vector (e.g., the 14-dimensional vector) can be referred to herein as a task distribution (or task representation), which is a probability distribution including a probability for each task represented in the K-dimensional vector (e.g., a probability for each task of the 14 tasks in a 14-dimensional task distribution vector). The probability for a given task in the probability distribution indicates the likelihood that a given sequence of commands is associated with the task. During training, a BTM task model is built (e.g., by exploiting the co-occurrence pattern using a BTM) that can determine a task distribution for each sequence of commands during the inference stage. Using the BTM task model built using the bi-term topic modeling, a K-dimensional task distribution vector can then be determined for each sequence of commands during the inference stage.

During inference (or run-time), after the task identification engine 102 has been trained, the task information can be modeled based on the commands that have been executed so far within a given session using the BTM. For example, the pre-trained BTM can be used during inference to obtain a task distribution (e.g., a 14-dimensional vector representation) at a given point in time, and because future commands that a user might execute after that point in time are not known, the command sequence observed so far is used to obtain the task distribution. The task distribution can be dynamically updated as more and more commands are executed by the user within the same sequence of commands. In some cases, the output of the pre-trained BTM can also be used to train the machine learning system implemented by the command recommendation engine 104 (e.g., the taskRNN and/or the task-based command prediction (TCP) model described below). In such cases, the BTM can be trained first, and the output can be used to train the machine learning system implemented by the command recommendation engine 104.

An example of topics generated by the BTM of the task identification engine 102 are shown in Table 1 and Table 2 below (where K=14). The example topics include “SegmentBuilder”, “MetricBuilder”, “ManageDataSource”, and “InitializeProject.” The commands (e.g., SaveSegment, ShowSegmentBuilder:Edit, RowActions:Preview, etc.) associated with each task are also shown in Table 1 and Table 2.

TABLE 1
Two sample tasks from BTM output

| Task 1: “SegmentBuilder” | Task 2: “MetricBuilder” |
|---|---|
| SaveSegment | DragDropSingleComponent |
| ShowSegmentBuilder:Edit | CalculatedMetricBuilderComponentDropped |
| RowActions:Preview | SaveCalculatedMetric |
| SegmentBuilderLoad | DragDropComponent:calculatedMetric |
| DragDropSingleComponent | ShowCalcMetricBuilder:Edit |
| ShowSegmentBuilder:New | ShowCalcMetricBuilder:New |
| DragDropComponent:dimension | DragDropComponent:calcmetric |

TABLE 2
Two more sample tasks from BTM output

| Task 1: “ManageDataSource” | Task 2: “InitializeProject” |
|---|---|
| VisualizationSettingChanged | ShowReportSuiteSelectorClick |
| ManageDataSource:LockSelection | ReportSuiteSwitch:NonVRS |
| ManageDataSource:LockSelectedPositions | DragDropComponent:dimension |
| ManageDataSource:UnlockSelection | DragDropComponent:metric |
| ManageDataSource:HideDataSource | TemplateOpened |
| SubPanelCollapse/Expand | LaunchPage:CreateNewProject |
| ManageDataSource:ShowDataSource | CalendarChange:adhoc:fixed |

The output of the task identification engine 102 can be used as input by the command recommendation engine 104. The obtained task distribution, denoted as TS for command sequence S, can be used to train a machine learning model of the command recommendation engine 104 during training, and can be used to guide the command recommendation engine 104 to determine one or more predicted or recommended commands during inference. For example, the command recommendation engine 104 can use the identified task to predict one or more commands (e.g., a next command 103). By incorporating the task information when determining the command recommendations, the commands that are unrelated to the ongoing task can be filtered out. In some cases, one or more predicted commands can be presented on the GUI of an application (e.g., as recommended commands in an analytics application or other software application) in a continuous manner as the user navigates the application. In some cases, the commands can be presented only when it is determined that help is needed, as described in more detail below.

The command recommendation engine 104 can model command recommendations through a machine learning system architecture by incorporating the task information at the input layer. In some cases, Markov Models can be used by the command recommendation engine 104. Oftentimes, Markov Models are the default choice for sequencing models that predict next occurrences in a sequence. In general, a Markov chain is a stochastic model describing a sequence of possible events in which the probability of each event depends only on the state attained in the previous event. An N-order Markov chain thus depends on the last N states for the prediction. One example of a Markov Model is a first order Markov Model. In a first order Markov Model, the number of previous commands that are considered for command recommendation is 1. The first order Markov Model can be described mathematically as follows:

P=Pr(Xₙ₊₁=x|Xₙ=xₙ),

which can be interpreted as the probability of a next command being x given the previous command that is observed is xₙ. This probability can be computed as follows.

$$P = \frac{count ( {X}_{n} \cdot {X}_{n + 1} )}{count ( {X}_{n} )} ,$$

which can be interpreted as the number of times Xₙ and Xₙ₊₁ occurred together out of the number of times Xₙ occurred in the corpus.

A first order Markov Model can also be described mathematically as follows:

cₜ₊₁=arg max_{ci∈C}Pr(c^{t+1}=cⁱ|cₜ),

where cⁱ is a command belonging to set of all commands C. For example, a first order Markov Model can compute the probability of the next action being cⁱ ∈C, given the previous action cₜ, to make predictions about the next command cₜ₊ᵢ.

Using a first order Markov Model, accuracy levels of 44.35% top 1 accuracy and 69.70% top 5 accuracy can be achieved. The top 1 accuracy is the percentage of split test sequences in which the predicted action is the ground truth. The top 5 accuracy is the percentage of split test sequences in which the ground truth is among the top 5 actions that are predicted.

More sophisticated models have been developed in order to increase the performance of the Markov Models. For example, variable length Markov Models consider a variable number (referred to as a length) of previous commands as context, instead of a fixed length context (e.g., a fixed length of 1 in a first order Markov Model). Variable length Markov Models can be helpful in many cases where exact N-length context might not occur frequently in the corpus. In such cases, the variable length Markov models use variable length sequences as the context. If the N-length context (where N can be a defined value) is not found in the model, then a shorter length context can be taken into consideration. For example, if Xₙ . . . Xₙ₋₁ . . . Xₙ₋₂ . . . X₁ is not present in the model, then a shorter sequence of Xₙ . . . Xₙ₋₁ . . . Xₙ₋ₖ for k>1 can be used as the context for prediction.

One example of a variable length Markov Model is a Probabilistic Suffix Tree (PST). In a PST, the root node is assigned a ‘null’ and every other node represents the sequence of commands that have to be executed in order to reach that node. The edge from a node to its children represents the probability of executing the next command in the sequence. Thus, given a sequence of commands that is represented as a node in a PST, the most probable future command can be determined by traversing the most probable edge from the node to its children.

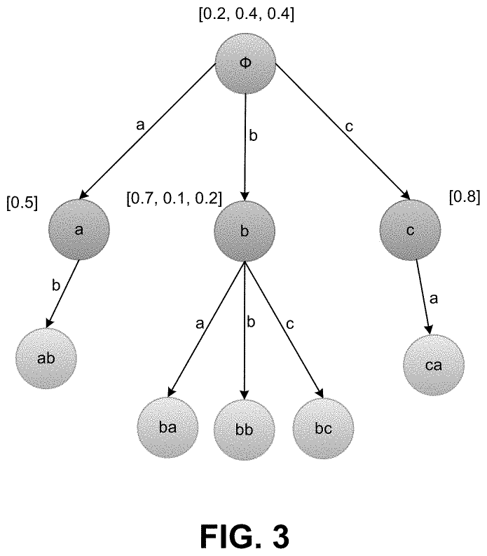

FIG. 3 is a schematic diagram illustrating an example of a PST. As shown, the PST is a tree where each node can have multiple children. Each node in the tree represents the sequence of commands, in reverse order, that have to be executed in order to reach that node. Each edge in the tree represents the command to be executed. The commands shown in FIG. 3 include commands a, b, and c, and the various sequences of commands include a, b, c, ab, ba, bb, bc, and ca. At each node, a probability distribution is shown (denoted as [x, y, z] or as [x]) that indicates the probability of a command to be executed given the sequence represented by the node that has been observed. For example, when at a certain node in the PST, any of the edges can be traversed to arrive at a node(s) one level down in the PST. The conditional probability of traversing the node(s) is represented by the number(s) next to the node. For example, while observing the “b” after the “phi” symbol (ϕ), the probability of executing “a”, “b” or “c” to arrive at “ba”, “bb”, or “bc”, respectively, is 0.7, 0.1, 0.2, respectively. The numbers in a given probability distribution may not sum up to a value of 1 because, in some cases, the PST can be pruned (e.g., by removing edges below a certain threshold) to ensure computational efficiency during test time. In some cases, the probability distribution can be computed for the entire command space (e.g., the probability with which each command in the command space can follow the sequence represented by the node).

Using the PST model shown in FIG. 3, the top 1 accuracy result is 56.33% and the top 5 accuracy result is 65.92%. Use of a variable length Markov model shows a significant improvement in the top 1 accuracy as compared to the first order Markov Model. The dip in the top 5 accuracy is due to a pruning method of a PST. For example, variable length contexts are allowed in PSTs, but the maximum depth of the PST is defined beforehand. Using the example form above, the average length of the sessions is 21, but for computing the i^{th} layer of PST, 267ⁱ sequences must be taken into account. In such an example, the PST max depth can be restricted to be 10. As the maximum depth is 10 and the number of commands is 267, the size of the PST size without pruning will be in the order of 267¹⁰, leading to the need of reducing the branching. To reduce the branching, several pruning methods are available for PSTs. One example is a thresholding method, where a sequence should appear more than a threshold number of times in a given corpus to be represented in the PST as a node. Any sequence that does not appear more than the threshold number of times can be pruned out and not used as a node in the PST.

To improve the accuracy levels of the PST, a task-aware PST (referred to as TaskPST) is provided herein. For each task identified by the topic model (e.g., a BTM) of the task identification engine 102, one dedicated PST can be trained using sequences that are most likely to belong to that particular task, resulting in one PST per task. For example, if there are K tasks identified using the BTM, the result is K PSTs. At test time, a sequence can be passed to all of the PSTs, and output from individual PSTs (which are probability distributions over the entire command vocabulary) are first weighted according to the task distribution of the test sequence, and then added to get the final output. This ensures that the final output of the command recommendation engine 104, which again is a probability distribution over the entire command vocabulary, is influenced proportionately by the output of individual PSTs based on the task distribution of the sequence.

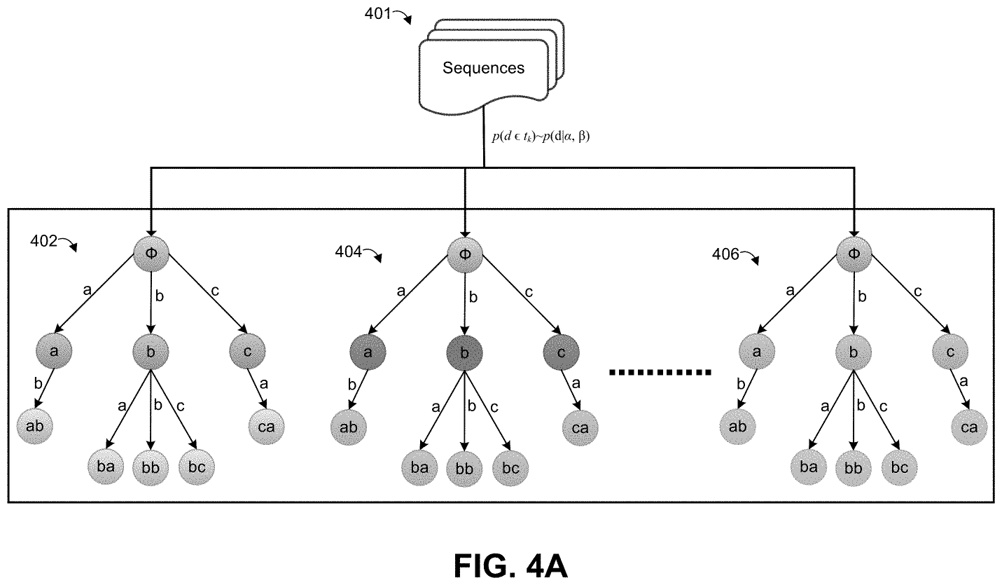

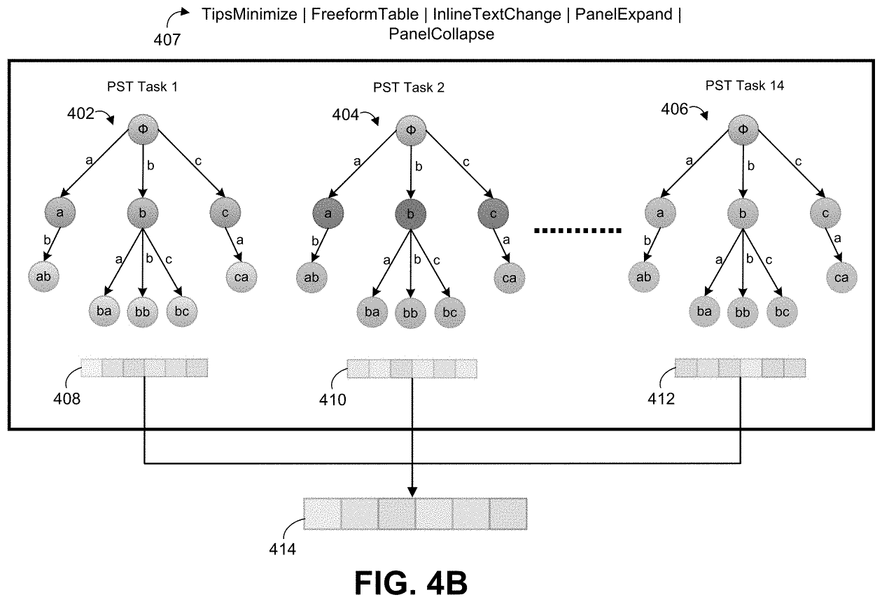

FIG. 4A and FIG. 4B are schematic diagrams illustrating an example of a TaskPST incorporating task information. By incorporating the task information, the command recommendation accuracy values generated by the command recommendation engine 104 can be improved. For example, the task information can be used by the command recommendation engine 104 to filter out unnecessary commands that are irrelevant to the ongoing task. Incorporating the task information in the PST can be difficult, as there is no provision in the PST to introduce the extra constraint of the task distribution. The constraints can thus be applied before constructing the PST itself. For example, if K tasks t₁, t₂, t₃, . . . , t_{K} are used (e.g., K=14 as used above), the task-aware command recommendation system 100 can perform various functions during PST construction. For instance, for each of the sequences in the corpus, the task distribution {p₁, p₂, p₃, . . . , p_{K}} can be generated by the task identification engine 102 using the BTM model, as explained above. The term pₖ is the probability that a given sequence belongs to i-th task. Further, during PST construction, the task identification engine 102 can use the task distribution to determine if a given sequence belongs to a task tₖ by sampling a random number r and checking if r>pₖ. In mathematical terms, the BTM probability distribution can be represented as:

p(d∈tₖ)˜p(d|∝,β),

where d is a sequence and the two Dirichlet priors α and β are hyperparameters. The Dirichlet priors α and β are shape parameters that determine the shape of a probability distribution. The β parameter can also be referred to as a beta parameter in some cases. A low value for the α and β hyperparameters will give rise to sharper distributions. In one illustrative example, α and β can be set to 0.001 and 0.005, respectively. For each task, the command recommendation engine 104 can construct a PST Pₖ from the sequences that belong to that task.

Referring to FIG. 4A, the input is the sequences of commands 401. The BTM probability distribution p(d∈tₖ) is determined based on the sequences of commands 401. A PST is then generated for each of the tasks, including a PST 402 (P₁), a PST 404 (P₂), through PST 406 (Pₖ). Using the example from above, 14 tasks (K=14) may be used, in which case 14 PSTs may be constructed. For the testing part of the training, the weighted average of the output from all the PSTₖ models can be used, which is illustrated in FIG. 4B. For example, the test sequence of commands 407 can be passed to all the PSTs (including PST 402, PST 404, through PST 406). As shown, the test sequence of commands 407 includes commands TipsMinimize, FreeformTable, InlineTextChange, PanelExpand, and PanelCollapse. An n-length vector (e.g., a 267-length vector using the example from above where there are 267 commands) can be generated by each of the PSTs 402, 404, through 406, with each element of the vector including the probability of command aᵢ being the next command (denoted as p(aᵢ|t=tₖ)). For example, the PST 402 generates the n-length vector 408, the PST 404 generates the n-length vector 410, and the PST 406 generates the n-length vector 412. The n-length vectors 408, 410, 412 output from the PST 402, the PST 404, through the PST 406 are weighted according to the probability of the test sequence 407 belonging to each PST (i.e the task associated with each PST), which can be denoted as follows:

p(aᵢ|t=tₖ)*p(d∈tₖ).

As shown by the above equation, the probability (denoted as p(aᵢ|t=tₖ) in the above equation) of a command aᵢ being the next command for a task tₖ is multiplied (i.e., weighted) by the probability (denoted as p(d∈tₖ) in the above equation) of the test sequence belonging to the tₖ task. The probability of each command being next in the sequence is then computed as the sum of the weighted probabilities (denoted as n-length vector 414 in FIG. 4B) from each of the PSTs 402, 404, through 406 (i.e., the weighted probabilities from each of the tasks tₖ), which can be denoted as follows:

$$p ( {a}_{i} ) = {\sum }_{{t}_{k} ∈ tasks} ( {a}_{i} \vert t = {t}_{k} ) * p ( d ∈ {t}_{k} )$$

Using the TaskPST, an improvement in the accuracy values can be obtained. For example, the top 1 accuracy value becomes 56.53% and the top 5 accuracy value becomes 66.55%. Limitations of the PST prevent the accuracy levels from increasing by a large margin. For example, PST works well for smaller command spaces. For a command space size, such as 267 commands in the example from above, thresholding needs to be used in controlling the tree size. Such a problem can be resolved using a Recurrent Neural Network (RNN), described in more detail below.

As noted above, the context of predicting a next word in language processing (e.g., in a document) is analogous to determining a command recommendation. For example, the next word is predicted given some sequence of words, or a text or paragraph is generated as a whole. The same problem is present in predicting command recommendations, but a major difference between these two problems is with the data type that is available. In language processing, there is a definitive structure (e.g., a structure of a document with words) and rules for one word to follow another word. For example, in the whole corpus of a document, an “a” is not typically observed following a “the”. However, for tasks of an analytics platform, there is no definitive sequence in which a task can be performed. There might also be one or more unnecessary commands (e.g., that are executed accidentally) that do not affect a task as a whole, but that can affect the command recommendation results. These problems can be solved using the task distribution information from task identification engine 102 when determining the command recommendation results. Using an RNN with task distribution information, the problems can be largely eliminated.

The command recommendation engine 104 can use an RNN to predict one or more commands. An RNN is a type of neural network where the outputs from previous time steps are fed as input to a current time step. For example, an RNN takes the output of the network from a previous time step as input and uses the internal state from the previous time step as a starting point for the current time step. In some cases, a particular type of RNN, called a multi-layered Long Short-Term Memory (LSTM) model, can be used to encode the input sequence of commands into command vectors of fixed dimensionality. The command vectors can then be used by another LSTM (a decoder) to generate commands that align with the context of the sequence exposed so far (based on the commands performed up to a current point in time). During the training phase, the generated command is compared to the ground truth command and the loss is backpropagated to update model parameters (e.g., the weights and/or biases of the RNN, such as the LSTMs). Mathematically, at each unfolding of the decoder LSTM, the following probabilities are computed to generate the next command cₜ₊₁ in the sequence S:

Pr(cₜ₊₁=cⁱ|c₀,c₁, . . . ,cₜ),

where {c₀, . . . , cₜ} are the commands, which are the LSTM model's input at different timesteps, and cⁱ represents i-th command in the universal command set C. Such an LSTM-based RNN can be referred to as a vanilla RNN (vRNN).

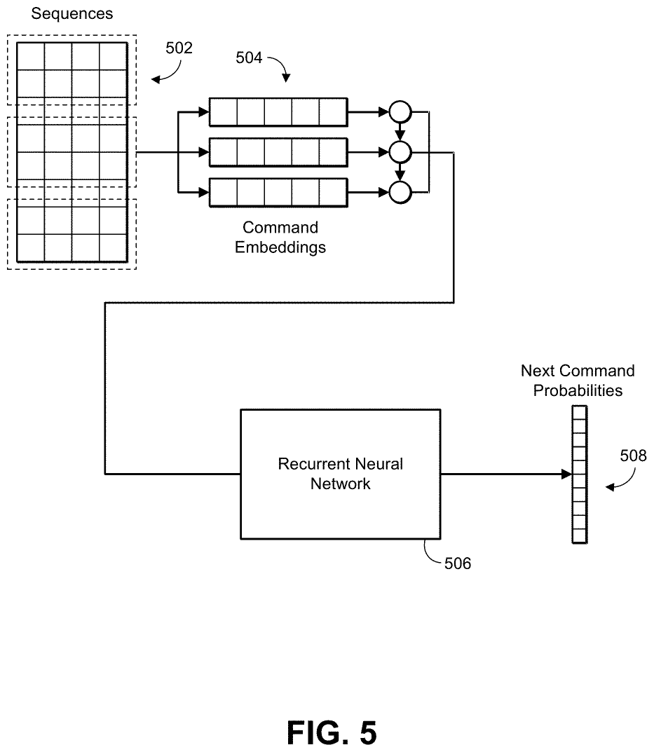

FIG. 5 is a schematic diagram illustrating an example of an RNN 506 that can be used by the command recommendation engine 104. The RNN 506 shown in FIG. 5 is an RNN without any modifications in the structure. For example, the RNN 506 can be an LSTM model, such as a vRNN.

The RNN 506 uses command embeddings 504 from one or more sequences 502 as input. As the sequence length of the data is restricted to a certain length (e.g., 21 as used in the above-described example), the RNN unfolding size can be set to the sequence length (e.g., an unfolding size of 21, corresponding to 21 recurrent operations). Each command can be learned as an m-sized embedding vector in the RNN 506 itself. For example, the first layer of the RNN 506 can learn each command's representation as a 32-sized embedding vector, represented in FIG. 5 as the command embeddings 504. The 32-sized embedding vectors are fed into the RNN 506 as input at each time step, along with the output to be predicted at each time step (which is the next command in the sequence). The final output of the RNN 506 includes predicted command probabilities 508 for the commands in the command space (e.g., 267 commands using the example from above). The predicted command probabilities 508 include a probability distribution of the set of possible commands (e.g., a first probability for a first command, a second probability for a second command, a third probability for a third command, and so on). With such an RNN architecture, the PST and TaskPST accuracies are outperformed by a significant margin. For example, the top 1 accuracy value is 53.8% and top 5 accuracy value is 76.6% when using an RNN-based architecture. While there is a dip in the top 1 accuracy, the top 5 accuracy incurs a significant improvement.

To further improve the performance of the RNN, a new task-based RNN is provided herein (referred to as TaskRNN) that incorporates the task information from the task identification engine 102 when predicting commands for recommendation. For the TaskRNN, the task distribution T_{S} for a sequence S obtained using the topic model (e.g., a BTM) can be concatenated with the trainable vector command embeddings, given by cⱼ. Based on this, the vRNN probability equation can be modified as follows:

Pr(cₜ₊₁=cⁱ|x₀,x₁, . . . ,xₜ),

where xⱼ=cⱼ⊕T_{S}. The notation ⊕ denotes vector concatenation. Serving ongoing task information as an additional input provides a broader context to the model and also helps in filtering out commands that may not be related to the current task.

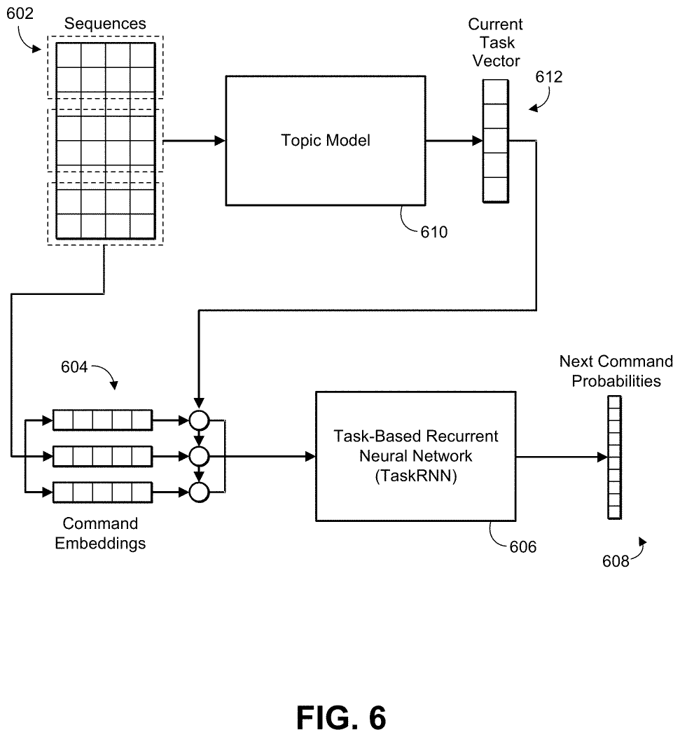

FIG. 6 is a schematic diagram illustrating an example of a TaskRNN 606 used by the command recommendation engine 104. In some cases, the TaskRNN 606 can be an LSTM model. Incorporating the task information improves the command recommendation accuracy values. As noted above, with the TaskPST, it was not possible to directly incorporate the task information into the PST model. However, with an RNN, the task distribution (including a probability distribution of the tasks in a sequence) can be used as an additional input vector to the RNN. For example, as shown in FIG. 6, the task distribution vector 612 output from the task identification engine 102 can be concatenated to the command embedding vectors 604 that are input to the TaskRNN 606.

Before implementing the TaskRNN 606 model, a topic model (e.g., a BTM) 610 of the task identification engine 102 is trained on the whole training data so that, given a sequence, the topic model 610 can output the task distribution for the sequence, as described above. The pre-trained topic model 610 can then be used in predicting the recommended commands. Similar to that described above with respect to FIG. 5, the TaskRNN 606 unfolding size can be set to the sequence length (e.g., an unfolding size of 21, corresponding to 21 recurrent operations). The commands from the one or more sequences 602 are (e.g., in parallel) fed into the pre-trained topic model 610 of the task identification engine 102. The output from the topic model 610 is the task distribution vector 612, which can be used in the TaskRNN 606. Each command from the one or more sequences 602 can be learned as an m-sized embedding vector in the TaskRNN 606 itself. For example, the first layer of the TaskRNN 606 can learn each command's representation as a 32-sized embedding vector, represented in FIG. 6 as command embeddings vectors 604. The 32-sized embedding vectors 604 are fed into the TaskRNN 606 as input at each time step, along with the output to be predicted at each time step (which is the next command in the sequence). As described below, before being input to the TaskRNN 606, the embedding vectors 604 can be concatenated with the task distribution vector 612.

The task distribution vector 612 is concatenated with each embedding vector of the embedding vectors 604, resulting in input vectors. For example, a first input vector can include the task distribution vector 612 concatenated with a first command embedding vector, a second input vector can include the task distribution vector 612 concatenated with a second command embedding vector, and so on. The resulting input vectors can then be fed into the TaskRNN 606. The final output of the TaskRNN 606 includes predicted command probabilities 608 for the commands in the command space (e.g., 267 commands using the example from above). The predicted command probabilities 608 include a probability distribution of the set of possible commands.

By concatenating the task distribution vector 612 with each of the embedding vectors 604 at the input layer, the TaskRNN 606 can derive the relation between the commands and the tasks. The relation between the commands and the tasks allows the TaskRNN 606 to filter out the irrelevant commands, and makes the command probability distribution output from the TaskRNN 606 more concentrated on the commands that are relevant to the identified task. For example, from a conceptual level, a first command embedding vector is provided to the TaskRNN 606 indicating that the first command was executed, along with the task distribution (task distribution vector 612) corresponding to the sequence to which the first command belongs. The probabilities within the task distribution vector 612 allow the command recommendation engine 104 to remove commands that are not relevant to the task.

Using the TaskRNN 606, the accuracy values are increased by a significant amount as compared to the previously-discussed command recommendation models. For example, the top 1 accuracy value came out to be 62.0% and the top 5 accuracy value came out to be 89.71%. This large improvement in accuracies is due to the incorporation of the task information and the resulting filtering of unnecessary commands.

The TaskRNN model assumes that the task distribution for an entire session is available at the start. While the task-aware command recommendation system 100 can have access to the entire sequence of commands at training time to determine the task distribution, it may not be available at testing time. For example, during the inference stage (or the test stage), a task distribution is developed as the task progresses, and with each command the task distribution converges to the final task distribution for the entire session. Accordingly, the task for an entire session itself may need to be predicted. For example, during the testing phase and during inference, only the task distribution of the sequence seen so far by the model are used, as opposed to using the task distribution of the entire sequence, as is done in the training phase. A modified TaskRNN model is described herein that can be used to predict the task distribution (e.g., based on commands up to a current point in time), and then predict the command based on the predicted task distribution. The modified TaskRNN can be referred to as a task-based command prediction (TCP) model.

The TCP model includes two sub-modules. The first sub-module is given as input a new command cₜ (in the sequence of commands) at timestep t, along with the task distribution (denoted as T_{St}) of the sequence observed so far (denoted as S^{t}). The first sub-module is responsible for predicting the task distribution if the whole sequence S were available, which is written as \hat{T}_{S}^{t}. During the training phase, the predicted task distribution is compared with the ground truth task distribution T_{S} using, as one illustrative example, Kullback-Leibler divergence. At each timestep t, the output \hat{T}_{S}^{t} of the first sub-module is concatenated with the trainable vector embeddings of the current command cₜ in the sequence, and a resulting input vector is used by the second sub-module to predict a next command cₜ₊₁ in the sequence. In the light of this modification, the vRNN probability equation can be re-written as follows:

Pr(cₜ₊₁=cⁱ|x₀′,x₁′, . . . ,xₜ′),

where x′ⱼ=cj⊕\hat{ }T^{j}_{S}. Because \hat{T}_{S}^{j} is computed using the part of the command sequence S^{j} observed so far, there is no heterogeneity between the training and test phase. The distinction between the “j” notation (e.g., in \hat{T}_{S}^{j}) and the “t” notation (e.g., in \hat{T}_{S}^{t}) is used because, for any given timestamp “t”, xᵢ values are used to represent x₀ through xₜ.

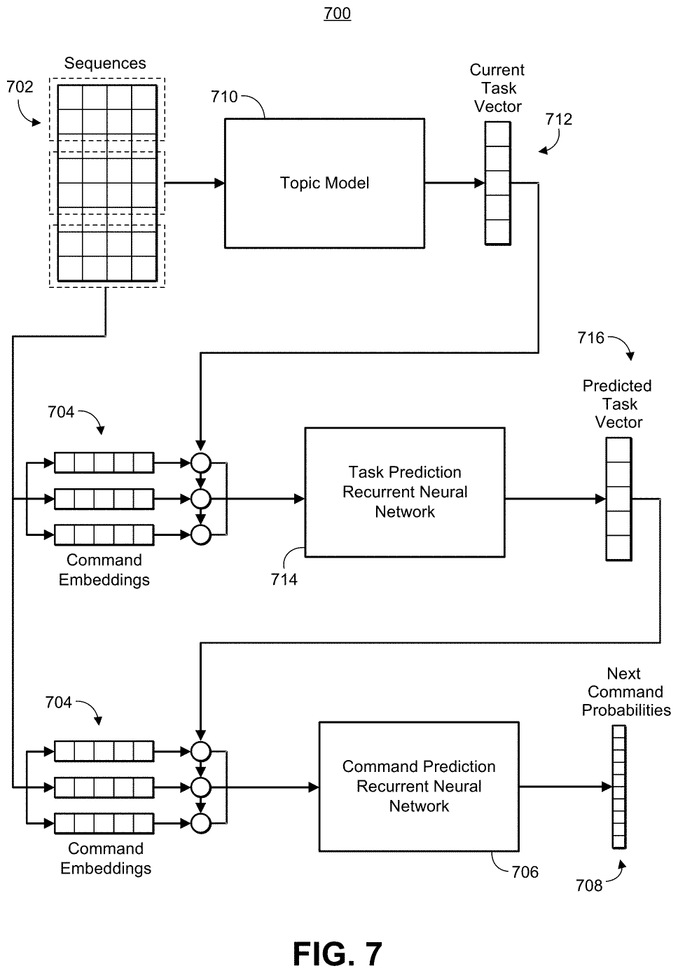

FIG. 7 is a schematic diagram illustrating an example of a TCP model 700 used by the command recommendation engine 104. The TCP model 700 includes a task prediction RNN 714 (referred to above as the first sub-module) and a command prediction RNN 706 (referred to above as the second sub-module). The TCP model 700 works similarly as the TaskRNN model, except that the task distribution vector that is concatenated at the input layer is determined using an additional machine learning model (e.g., an RNN). For example, instead of using a task distribution that is output from a topic model, a task distribution 716 can be predicted using the task prediction RNN 714. In some cases, the task prediction RNN 714 can be a different RNN than the command prediction RNN 706. In some cases, the task prediction RNN 714 can part of the same neural network as the command prediction RNN 706. In some cases, the task prediction RNN 714 and the command prediction RNN 706 can be LSTM models.

Before implementing the TCP model 700, a topic model (e.g., a BTM) 710 of the task identification engine 102 is trained on the whole training data. As described above, given a sequence, the pre-trained topic model 710 can output the task distribution for the sequence. Similar to that described above, the RNN unfolding size can be set to the sequence length (e.g., an unfolding size of 21, corresponding to 21 recurrent operations) for the task prediction RNN 714 and the command prediction RNN 706. Each command from the one or more sequences 702 can be learned as an m-sized embedding vector in the task prediction RNN 714. For example, the first layer of the task prediction RNN 714 can learn each command's representation as a 32-sized embedding vector, represented in FIG. 7 as command embeddings 704. The command embeddings 704 are also used in the command prediction RNN 706.

The commands from the one or more sequences 702 are (e.g., in parallel) fed into the pre-trained topic model 710 (e.g., a BTM) of the task identification engine 102. The output from the topic model 710 is the task distribution vector 712 for the commands that have been observed up to a current point in time. The task distribution vector 712 can then be used in the task prediction RNN 714. The 32-sized embedding vectors are also fed into the task prediction RNN 714 as input at each time step, along with the output to be predicted at each time step (which is the task distribution for the whole session). For instance, the task distribution vector 712 is concatenated with each embedding vector of the embedding vectors 704, resulting in input vectors. In one example, a first input vector can include the task distribution vector 712 concatenated with a first command embedding vector, a second input vector can include the task distribution vector 712 concatenated with a second command embedding vector, and so on. The resulting input vectors can then be fed into the task prediction RNN 714.

The output of the task prediction RNN 714 will be a K-dimensional vector (where K is the number of tasks), which is the predicted task distribution 716 for the whole session. The predicted task distribution 716 can then be concatenated to the command embedding vectors 704, and the resulting input vectors can be fed into the command prediction RNN 706. The final output of the command prediction RNN 706 includes predicted command probabilities 708 for the commands in the command space (e.g., 267 commands using the example from above). The predicted command probabilities 708 include a probability distribution of the set of possible commands.

In addition to being able to predict the task distribution for the entire session (e.g., based on commands up to a current point in time), and then predict a command based on the predicted task distribution, another advantage of the TCP model 700 is the ability to rank different tasks that a user will be performing in the current session, which enables the task-aware command recommendation system 100 to understand what task the user wants to perform in the current session.

The help modeling engine 106 can perform help prediction to identify whether the user needs help at a certain point in time while working with an application. The help prediction can also be applied in domains other than for use in analytics applications. The help modeling engine 106 can dynamically monitor a user's interaction with the GUI of an application (e.g., an analytics application or other software application) and, if need be, can proactively recommend the user to seek help (e.g., by highlighting a help icon, displaying a link to a document and/or video, etc.) along with providing command recommendations. For instance, a help model of the help modeling engine 106 can be run at the backend, and if it is determined that the user needs help, the help modeling engine 106 can output help data 105. The help data 105 can include one or more recommended commands. The help data 105 can also include other information related to the task being performed and/or the one or more recommended commands. For example, once a user is determined to need help, the help modeling engine 106 can proactively present the one or more command recommendations and/or other information that can help the user complete the ongoing task. In some cases, the command recommendations can be provided at all times, regardless of whether it has been determined that the user needs help.

The help prediction can be modeled through a machine learning system architecture (e.g., a recurrent neural network (RNN)-based architecture, such as a long-short term memory (LSTM)-based architecture, or other machine learning or neural network architecture) that captures a time gap between successive commands in the task and predicts when the user is going to need help with the task. The machine learning system architecture can also be referred to as a binary classification machine learning system. In some implementations, for determining when the requires help, a random forest classifier and an RNN (e.g., an LSTM) can be trained with a user's recent sequences of commands, along with the time the user took in executing those commands, as an input to the classifier.

For example, the help recommendation model can be formulated as a supervised binary classification problem, for which the data comprises of positive (i.e., help sequences) and negative sequences, as described above. A binary classification machine learning system can be used to determine whether help is needed. In one illustrative example, a random forest classifier (RFC) and/or an LSTM classifier can be trained for the help-based classification problem. For the RFC and LSTM models, to incorporate the temporal information, the time interval Δt between execution of current command cₜ and the previous command cₜ₋₁ can be concatenated with the trainable vector embedding of the current command cₜ. During training, the LSTM classifier takes the concatenation of time interval Δⱼ and cᵢ as input at each timestep j, and the output of the final unfolding of LSTM is passed through a fully-connected neural (FCN) layer to output binary class probabilities, given by the following:

Pr(yₜ=class|c₀⊕Δ₀,c₁⊕Δ₁ . . . ,cₜ⊕Δₜ),

where class ∈ {help, no_help}. During testing, all the settings are the same as the settings used during training, except that the output of every unfolding of the LSTM is passed through an FCN layer to output the binary class probabilities (whereas during training the final unfolding is passed through the FCN layer). Incorporating time intervals between consecutive commands, along with the vector embeddings of the commands, allows the model to implicitly learn some of the heuristics discussed below (e.g., abrupt long pauses, frequent searches, among others).

Various heuristics can be modeled implicitly in order to determine whether or not the user currently needs help. One example includes undesired effects, where if a user is not sure of the next command(s) or is confused about how to perform a command, the user will try different options available in the workspace and will probably undo them. Another example of a heuristic is an inefficient command sequences. For instance, if a user takes longer routes to finally reach a point (e.g., a task, part of a task, or the like) that can be easily achieved through a fewer number of commands, the user can be made aware of the commands that can be performed to reach that same point. Another example of a heuristic is introspection, where if a user suddenly stops working or starts taking longer pauses compared to the user's earlier workflow, the user may be confused at this stage of the task. In some cases, modeling introspection can be user specific, as different users can have different pace of working things out. Another example is a search. For instance, if a user is performing too many commands related to a search, the user may require help with certain areas of an analytics platform. The help modeling engine 106 can use the search content to determine the area or topic for which the user needs help. Focus of attention is another example of a heuristic, where a user may pay attention to (e.g., pause or focus on) certain areas of a GUI of a software application, which can be estimated using the scrolling speed of user or other suitable technique.

As noted above, the log data 101 can be provided as input to the task-aware recommendation system 100. For the help modeling engine 106, the same usage log data can be used as that used for the task identification engine 102 and the command recommendation engine 104, but additional pre-processing steps can be carried out in addition to those discussed above. The sessions can be searched for commands that can be used as an indication for providing help. For example, a certain subset or number of commands from the entire set of identified commands can be identified as commands indicating help is needed. Using the illustrative example from above, out of the 267 commands, 14 commands can be identified (e.g., manually or automatically based on heuristics) as commands that indicate that a user needs help (e.g., a command including a click on a help icon, an inefficient command sequence, frequent searches, abrupt long pauses, frequently using undo commands, among others). All sequences where any command from the subset of commands (e.g., the 14 commands) occurs for the first time, after a k-th position in the sequence, can be denoted or labeled as help sequences. The k-th position in the sequence can be used as a constraint to allow the first k commands of a help sequence to be used by the help modeling engine 106 to obtain some context before help is sought. The sequences that were identified as help sequences can be trimmed to remove the portion after which help was sought, and can be used as positive examples to train and test the help modeling engine 106. Using the example from above, 4,300 positive examples can be identified as help sequences. In some cases, examples that could be explicitly called negative (help was not required) may not be available. Such non-availability of examples that could be explicitly called negative can be compensated for by using randomly sampled sequences (e.g., 20,000 sequences from the example above) that were not identified as help sequences.

The models of the help modeling engine 106 can be trained using supervised learning. After each command, the help modeling engine 106 can predict whether the user needs help or not. For training, a certain number of unlabeled sequences can be randomly chosen (e.g., 21,500 unlabeled sequences) and can be marked as instances which clearly indicate the user does not require help. This completes the training set with approximately twenty percent of the examples as instances of help. The test set can include 559 help instances out of 72,091 sessions. All the unlabeled sequences in the test set are considered as instances which do not indicate the presence of help, even though in some cases users may choose the option of getting help outside of the software application.

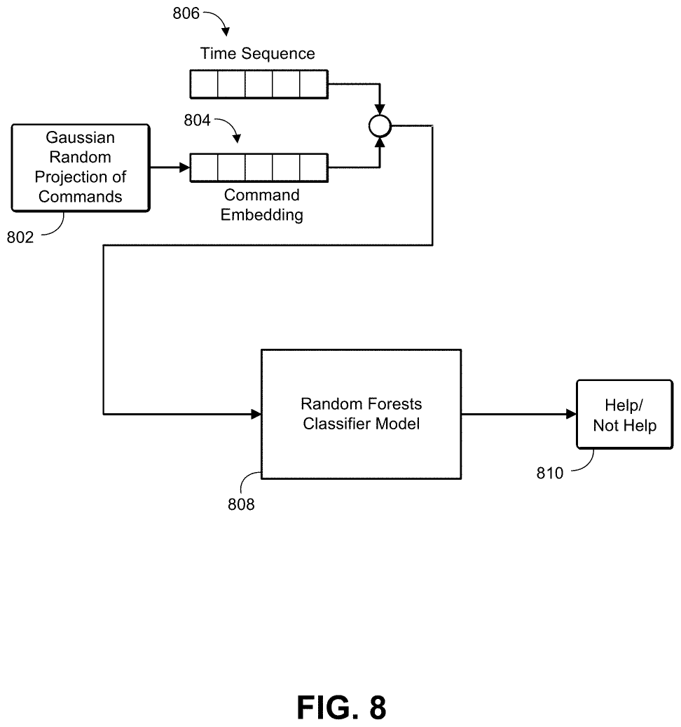

As noted above, a random forests classifier (RFC) and/or an LSTM classifier can be used by the help modeling engine 106. The high performance of these models can be attributed to the categorical nature and notion of sequence in data respectively. FIG. 8 is a schematic diagram illustrating an example of an RFC model 808 of the help modeling engine 106. The command embeddings 804 for the RFC model 808 are created by projecting a one-hot matrix of a certain size (e.g., 267×267 using the example above of 267 unique commands) using a Random Gaussian Projection 802 to finally create an embedding of 8 dimensions for all the unique commands (e.g., for the 267 unique commands from the above example). A time sequence 806 for each command embedding is also provided as input to the RFC model 808. The time sequence 806 can include, for a given command, a time gap between the given command and a previous command (e.g., a time interval Δt between execution of current command cₜ and the previous command cₜ₋₁). The command embeddings for a number of recent commands concatenated with the corresponding time sequence 806 information for the commands can be provided as input to the RFC model 808. The RFC model 808 can output a binary classification 810, with a first binary value (e.g., a 1) indicating help is needed and a second binary value (e.g., a 0) indicating help is not needed.

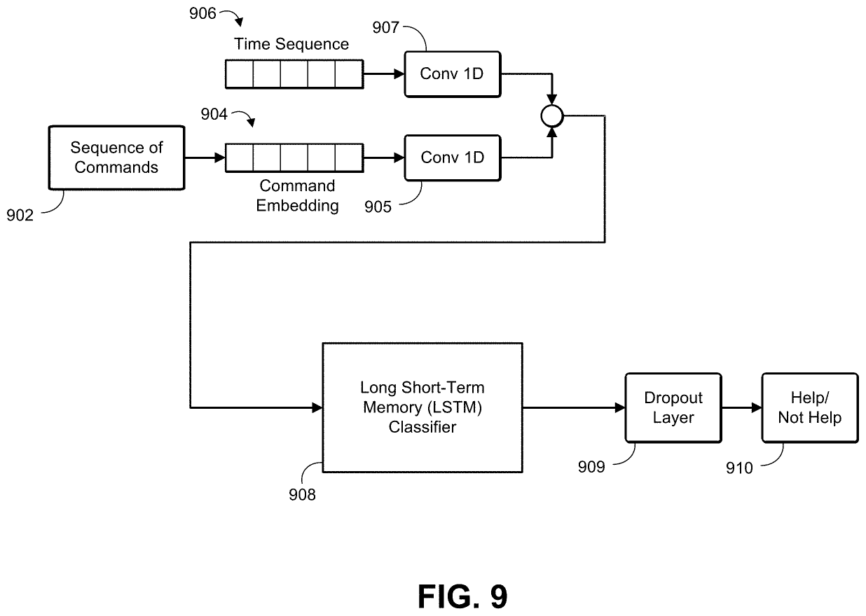

FIG. 9 is a schematic diagram illustrating an example of an LSTM classifier 908 of the help modeling engine 106. The command embeddings 904 in the LSTM classifier 908 are learned from the sequences of commands 902. For example, during a first iteration of the model of the LSTM classifier 908 (when the model has not yet learned anything), the command embeddings are randomly initialized. Over second, third and further iterations, the random command embeddings are updated (in effect, learned) in order to minimize the loss function (which relates to predicting the correct next command in the sequence). For help prediction, the learned command embeddings are used to determine a binary classification.

A time sequence 906 for each command embedding is also provided as input to the LSTM classifier 908. Similar to that described above, the time sequence 906 can include, for a given command, a time gap between the given command and a previous command. Both the learned embeddings 904 and the time sequence 906 for the recent commands are passed through a one-dimensional convolution layer (including 1D convolutional layer 905 and 1D convolutional layer 907) with a given kernel size (e.g., a kernel size of 4). The output from the 1D convolutional layers 905 and 907 are then concatenated and passed to the LSTM classifier 908 with a dropout layer 909. The dropout layer 909 can be used as a regularization method where input and recurrent connections to LSTM units are probabilistically excluded from activation and weight updates while training the neural network. The dropout layer 909 can reduce overfitting the training data and can improve the performance of the LSTM. The LSTM classifier 908 can output a binary classification 910, with a first binary value indicating help is needed and a second binary value indicating help is not needed.

In some cases, only the command sequences can be provided as input to the RFC model 808 and/or the LSTM classifier 908, while in other cases the time sequence (e.g., the time sequence 806 and/or the time sequence 906) of the commands and the command sequences can be provided as input. Results of both scenarios are provided in Table 5 below.

For testing the models of the task identification engine 102, the command recommendation engine 104, and the help modeling engine 106, each test sequence can be broken down into multiple test cases, as shown in Table 3 below.

TABLE 3
Split test cases generated for original
test sequence: “ababcabcdcefd”

| Test | Ground |
|---|---|
| Sequence | Truth |
| ababcabc | d |
| ababcabcd | c |
| ababcabcdc | e |
| ababcabcdce | f |
| ababcabcdcef | d |

As the context length to predict a command will be small for shorter sequences, the minimum number of actions in a context can be restricted to a certain number, such as 8. Using 8 as an example, the split sequences will have minimum length of 8 actions, as shown in Table 3.

For the testing phase, the split sequences are taken as the final test cases. The top 1 accuracy is the percentage of split test sequences in which the predicted action is the ground truth. The top 5 accuracy is the percentage of split test sequences in which the ground truth is among the top 5 actions that are predicted. Table 4 below summarizes the results of all the command recommendation models:

TABLE 4
Results of Command Recommendation Models

| | First order | | | | | |
|---|---|---|---|---|---|---|
| Model | MM | PST | TaskPST | RNN | TaskRNN | TCP |
| Top 1 | 44.35 | 56.33 | 56.53 | 53.8 | 62.0 | 57.5 |
| Top 5 | 69.70 | 65.92 | 66.55 | 76.6 | 89.71 | 79.18 |

As can be observed from Table 4, models that incorporate task information, in general, perform better than those that do not. As described above, the task information guides the process of recommending a next command and leads to better command recommendation results.

Table 5 below summarizes the results of all the Help prediction models:

TABLE 5
Results of Help Prediction Models

| Help Prediction | | | F1- | | AU- |
|---|---|---|---|---|---|
| Models | Precision | Recall | score | AU-PRC | ROC |
| Random Forest | 0.0852 | 0.2719 | 0.1297 | 0.1149 | 0.7590 |
| (Commands only) | | | | | |
| Random Forest | 0.1167 | 0.2629 | 0.1616 | 0.1641 | 0.7133 |
| (Time concatenated | | | | | |
| with commands) | | | | | |
| LSTM Classifier | 0.1084 | 0.3059 | 0.1601 | 0.1945 | 0.7886 |
| (Commands only) | | | | | |
| LSTM Classifier | 0.1279 | 0.2934 | 0.1781 | 0.1964 | 0.7941 |
| (Time concatenated | | | | | |
| with commands) | | | | | |

As seen from Table 5, an improvement in scores occurs for the second case, confirming the use of introspection as a heuristic. Upon going through the sequences which are predicted as true positives by the classifiers, commands like clicking a search icon and pressing an undo button are frequent, which confirms the use of undesired effects and search commands as heuristics. Also, repetition of commands in the loop can be seen, which confirms the use of inefficient command sequences as a heuristic. From Table 4, it can be observed that LSTM-based classifiers perform better than Random Forest baselines, and concatenating time interval Δₜ leads to an improvement in results for both the classifiers.

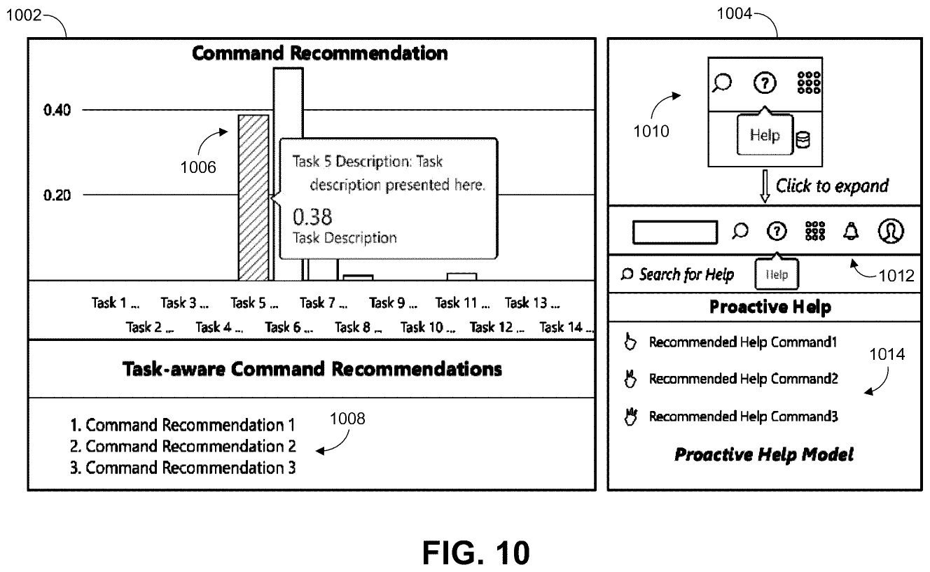

FIG. 10 is an image illustrating an example of a graphical user interface (GUI) 1000 of a task-aware command recommendation system. The GUI 1000 can be incorporated into a GUI of a software application, such as an analytics application in some implementations, or any other suitable software application that includes commands that need to be executed to complete one or more tasks. The GUI 1000 includes a command recommendation panel 1002 and a proactive help panel 1004. The command recommendation panel 1002 includes graphics illustrating a task distribution 1006 of the ongoing sequence of commands, which can be determined by the task identification engine 102. The name of each task (e.g., task 1, task 2, through task 14) is provided with the distribution values (or probabilities) of each possible task (e.g., a value of 0.38 for task 5). The task distribution 1006 of the sequence of commands is used to recommend future commands, illustrated as task-aware command recommendations 1008. As shown, the task-aware command recommendations 1008 include a command recommendation 1, a command recommendation 2, and a command recommendation 3. The task-aware command recommendations 1008 can include the highest probability command recommendations determined by the command recommendation engine 104 based on the probability distribution of the possible commands (e.g., sum of the weighted probabilities denoted as n-length vector 414 in FIG. 4B, predicted command probabilities 508 in FIG. 5, predicted command probabilities 608 in FIG. 6, or predicted command probabilities 708 in FIG. 7).

As shown in the proactive help panel 1004, a proactive help icon 1010 on the GUI is highlighted when it is determined that a user needs help with the software application. Additional information is presented on the GUI when the help icon 1010 is selected. For example, once the help icon 1010 is selected, a toolbar 1012 on the GUI expands to expose recommended help commands 1014 (including recommended help command 1, recommended help command 2, and recommended help command 3). In some cases, the recommended help commands 1014 can be the same as the task-aware command recommendations 1008. In some cases, the recommended help commands 1014 can be different than the task-aware command recommendations 1008.

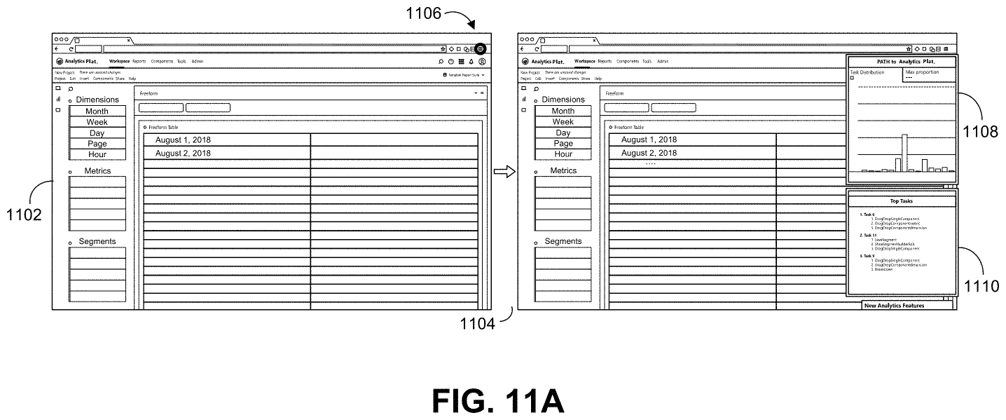

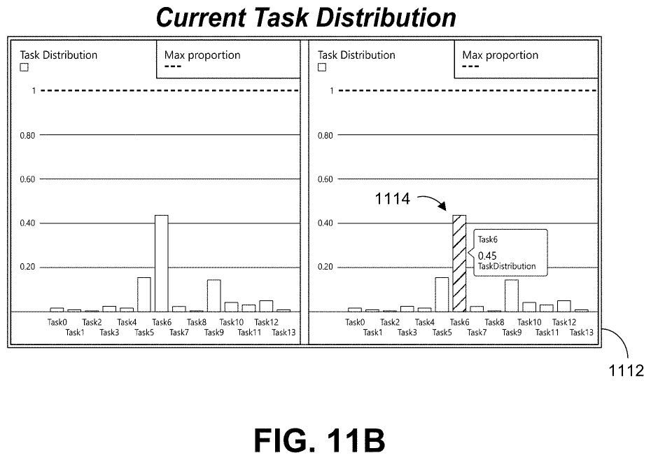

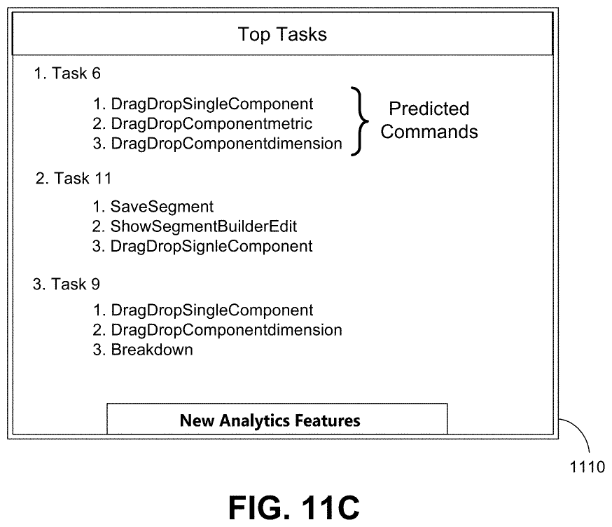

FIG. 11A is a diagram including images illustrating aspects of a GUI 1100 of an analytics application with a task-aware command recommendation system. The GUI 1100 shown in FIG. 11A is a web-based GUI implemented through a web browser, where the task-aware command recommendation system is provided as a browser extension that facilitates interaction between the frontend (the GUI 1100 and the computing device operating the GUI) and the backend (the one or more servers or other devices providing the task-aware recommendation services described above). In some implementations, the GUI 1100 can be part of a mobile or desktop application, or other program or application. A user's interaction with the GUI 1100 is monitored in real-time and a sequence of commands is sent to the models of the task-aware recommendation system (e.g., the task identification engine 102, the command recommendation engine 104, and the help modeling engine 106) in the back-end.

The GUI 1100 includes an initial layout 1102 that is used for normal operation of the analytics application (when the command recommendation system is not being used). When a user clicks on a browser extension icon 1106, a command recommendation layout 1104 appears. The command recommendation layout 1104 includes two sections, including a first section 1108 with a bar graph showing the task distribution based on a current sequence of commands performed by the user up to a current point in time. The name of each task (e.g., task 1, task 2, through task 14) is provided with the distribution values (or probabilities) of each possible task. FIG. 11B shows the task distribution from the first section 1108, along with a window highlighting a task 1114 with the highest probability (task 6 with a probability of 0.45) from the task distribution.

The task distribution of the sequence of commands is used to recommend future commands, shown in the second section 1110 of the command recommendation layout 1104. The second section 1110 of the command recommendation layout 1104 includes a list of tasks, along with the commands within those tasks that should be committed next in order to continue with or complete the task. An enlarged version of the second section 1110 is also shown in FIG. 11C. As shown in FIG. 11A and FIG. 11C, the identified tasks include task 6, task 5, and task 9, which include the three tasks with the highest probabilities from the task distribution shown in section 1108 of the GUI 1100. The recommended commands for task 6, task 5, and task 9 include the respective top 3 commands with the highest probability from the probability distribution of the possible commands for each task (e.g., sum of the weighted probabilities denoted as n-length vector 414 in FIG. 4B, predicted command probabilities 508 in FIG. 5, predicted command probabilities 608 in FIG. 6, or predicted command probabilities 708 in FIG. 7).

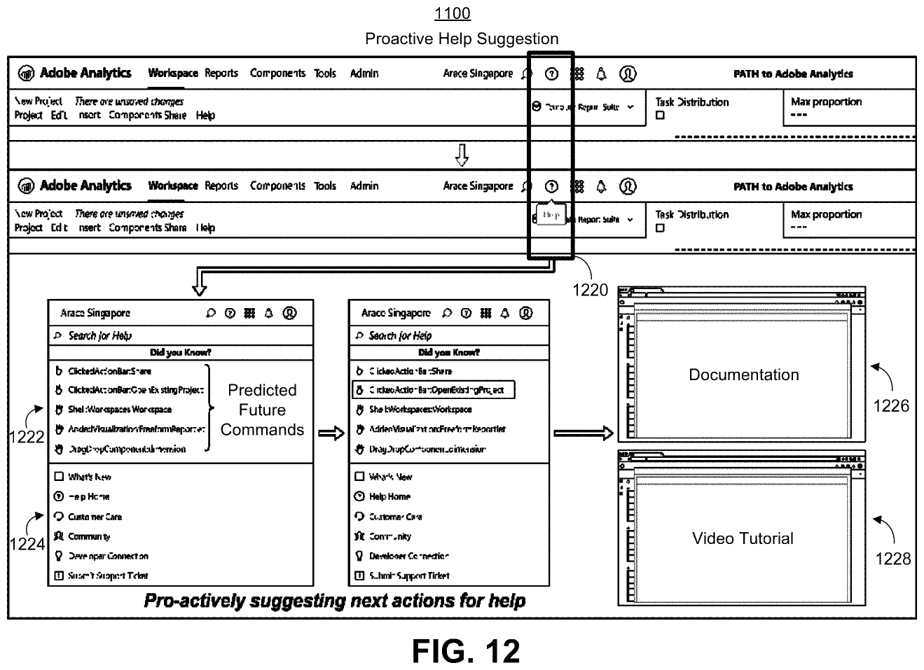

FIG. 12 is a diagram including images illustrating additional aspects of the GUI 1100 providing proactive help. The help modeling engine 106 monitors a user's interaction with the GUI 1100 and suggests that the user should seek help by highlighting the help icon 1220 (e.g., by changing the color of the help icon 1220 from gray to red). The user can click on or otherwise select (e.g., using a gesture, an eye gaze, or other suitable input) the help icon 1220, causing a list of predicted commands 1222 and additional information 1224 to be presented. The list of predicted commands 1222 can include commands the user should commit in order to continue with or complete the current task being performed by the user. The user can click or otherwise select any of the predicted commands from the list of predicted commands 1222, which can cause options to be provided for the user to select documentation or one or more videos explaining how to perform commands, and in what order, to allow the user to complete the task. For example, a new window 1226 can be presented with documentation explaining how to perform the commands. In another example, a new window 1228 can be presented with a video tutorial.

Using the techniques described herein, the task-aware command recommendation system 100 can predict one or more commands that a user should execute and can, in some cases, combine the predicted one or more commands with a help predictor model to proactively help the user with an ongoing task. As described above, the task-aware command recommendation system 100 identifies user tasks (in an unsupervised manner using topic modelling), and uses the identified tasks to recommend future commands. Incorporating the task information while predicting one or more next commands in a sequence of commands allows the system 100 to have a larger context outside of current command sequence.

The task-aware command recommendation system 100 can also proactively suggest users to seek help when it is determined the users are stuck. The help modeling engine 106 can, based on prior heuristics, detect user activities (e.g., inefficient command sequences, frequent searches, abrupt long pauses, frequently using undo commands, among others) that indicate the need for help. Instead of explicitly modeling the heuristics as assumptions using a complicated rule-based model, the help modeling engine 106 can model the heuristics implicitly using data-driven approaches. By helping users make progress based on the task of the user, the task-aware command recommendation system 100 can increase efficiencies of completing a task (e.g., reduce time to value), and can increase workspace adoption by users. Because the task-aware command recommendation system 100 identifies the current task that a user is performing and leverages that task information to proactively help the user by presenting one or more recommended commands that they should execute, the system can be integrated with the any suitable software application infrastructure (e.g., an analytics application infrastructure or any other interactive tool) to help the users interact in an effective manner. For example, by changing the log data, the hyper parameters of the machine learning systems, the number of tasks in the task model, and/or other parameters, the task-aware command recommendation system 100 can be applied to any interactive product.

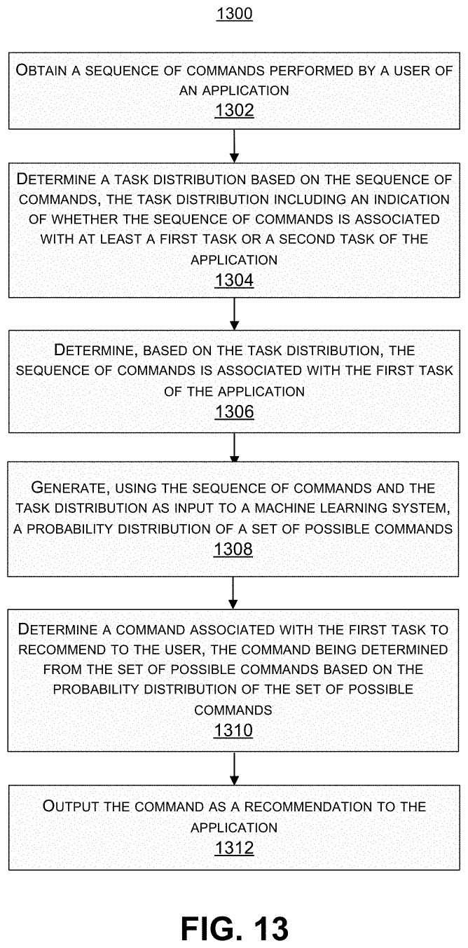

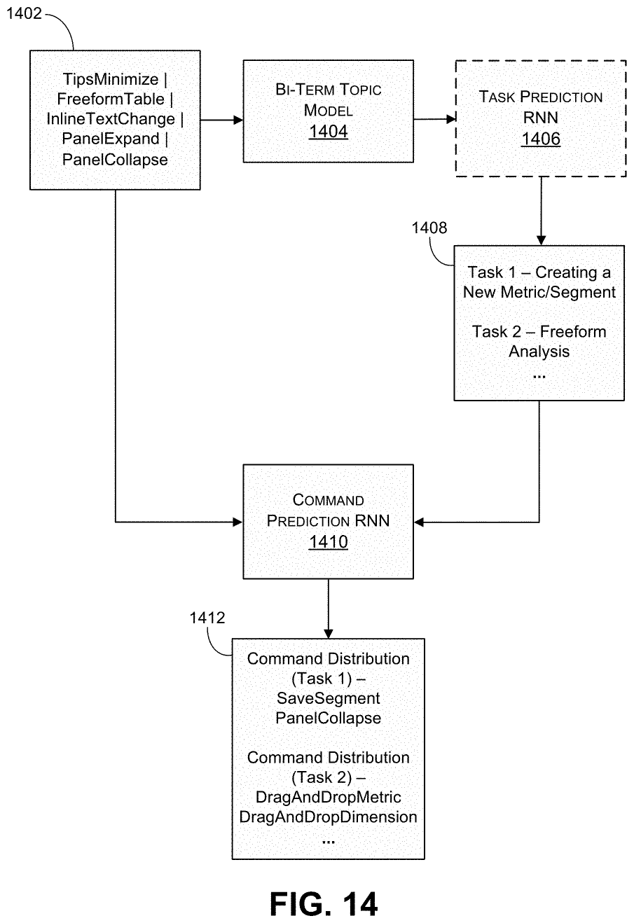

An example of a process performed using the techniques described herein will now be described. FIG. 13 is a flowchart illustrating an example of a process 1300 for determining one or more recommended commands. FIG. 14 is a block diagram illustrating an example implementation of the process 1300 shown in FIG. 13. At block 1302, the process 1300 includes obtaining a sequence of commands performed by a user of an application. For example, the sequence of commands can include the commands performed by a user up to a current point in time. The application can include an analytics application or other type of software application that includes commands needed to perform one or more tasks.

An example of a sequence of commands 1402 is shown in FIG. 14. In one example using an analytics application as an illustrative example, the sequence of commands 1402 can include the following commands: TipsMinimize, FreeformTable, InlineTextChange, PanelExpand, and PanelCollapse. The TipsMinimize command is logged when a user minimizes a “New Analytics Features” banner, which displays recent updates in the analytics application. While the TipsMinimize command may not correspond to any particular task, a user would typically minimize the banner before proceeding with any tasks. The FreeformTable is logged when the user uses the application to create a freeform table. A freeform table allows a user to drag and drop various items, including metrics, dimensions, and segments, enabling the user to explore how various metrics can change with respect to various dimensions and segments. The PanelExpand command is logged when a user clicks on a button or icon to create a new metric or segment. This allows the user to use the application to create custom metrics and segments, which further allows the user to do a freeform exploration using these metrics or segments. While creating a new metric or segment, the application provides an option for a user to write a description in a textbox for the custom metric or segment that is being creating. When the text within the textbox is changes, the InlineTextChange command is logged. The PanelCollapse command is the conjugate command for PanelExpand, and is logged when the textbox (or panel) is closed.

At block 1304, the process 1300 includes determining a task distribution based on the sequence of commands. The task distribution includes an indication of whether the sequence of commands is associated with at least a first task or a second task of the application. For instance, the task distribution can include a probability for each task represented in the task distribution. As noted above, the task distribution can be a K-dimensional vector, with K being the number of topics that are to be determined for a given session. Using 14 topics as an illustrative example, the task distribution can be a 14-dimensional task distribution vector having 14 probabilities (including one probability for each task of the 14 tasks).

In some cases, the task distribution can be determined based on unsupervised topic modeling using a bi-term topic model (BTM), as described above. For example, as shown in FIG. 14, the bi-term topic model (BTM) 1404 can receive the sequence of commands 1402 as input, and can output a task distribution 1408. As described above, the BTM 1404 can be built using bi-term topic modeling that directly models the generation of command co-occurrence patterns (i.e. biterms) in the corpus. The corpus is a mixture of tasks, and each biterm is drawn from a specific task independently. The probability that a biterm is drawn from a specific task is further captured by the chances that both words in the biterm are drawn from the task. For example, using the bi-term topic modeling, a task (or topic) assignment of each biterm can be sampled from a conditional distribution of each biterm, and task assignment counters can be updated. After sufficient sampling is performed, the model parameters of the BTM 1404 can be computed using the task assignment counters for a biterm task. The co-occurrence patterns of commands across all the sequences of commands can then be used to learn a common model for the BTM 1404. Once built, the BTM 1404 can receive sequences of commands perform by a user up to a certain point in time, including the sequence of commands 1402, and can generate a predicted task distribution 1408 based on the sequence of commands 1402. In some examples, the task distribution 1408 output by the BTM 1404 and the sequence of commands 1402 can be used to determine (e.g., using the TaskRNN described above) a probability distribution 1412 of a set of possible commands, as described in more detail below.

In some examples, an output of the BTM and the sequence of commands can be used by an additional machine learning system to determine the task distribution. Such examples can be implemented using the task-based command prediction (TCP) model described above. For example, referring to FIG. 14, a current predicted task distribution can be output by the BTM 1404. The current predicted task distribution is the task distribution (denoted above as T_{St}) of the sequence of commands 1402 (denoted above as S^{t}) performed by a user and observed so far up to a current point in time. The current task distribution can be provided from the BTM 1404 to the task prediction RNN 1406 (which is optional as shown by the dashed outline) for predicting the task distribution 1408, which is the predicted task distribution as if the entire sequence S were available. The task prediction RNN 1406 can be the first sub-module (e.g., the task prediction RNN 714) of the TCP model described above with respect to FIG. 7.

In one example using an analytics application and the sequence of commands 1402 as an illustrative example, the task distribution 1408 can include a first task having a highest probability in the task distribution 1408 and that relates to creating a new metric segment. The task distribution 1408 can also include a second task having a second highest probability in the task distribution 1408 and that relates to freeform analysis. As indicated by the “ . . . ” notation in FIG. 14, the task distribution 1408 can include other tasks related to the sequence of commands 1402.

At block 1306, the process 1300 includes determining, based on the task distribution, that the sequence of commands is associated with at least the first task of the application. In one illustrative example, referring to FIG. 14, the task distribution can include at least a first probability that the sequence of commands is associated with the first task (creating a new metric/segment) and a second probability that the sequence of commands is associated with the second task (freeform analysis). The first task can be determined to be performed by the user based on the first probability being greater than the second probability. For example, it can be determined from the task distribution 1408 that the sequence of commands is associated with the first task (creating a new metric/segment) based on the first task having a highest probability as compared to other tasks in the task distribution 1408. In some examples, multiple tasks can be determined from the task distribution as possibly being performed by the user (e.g., the top three most probable tasks in the task distribution), in which case one or more commands can be recommended for each possible task. For example, it can be determined from the task distribution 1408 that the sequence of commands is also associated with the second task (freeform analysis) based on the second task having a second highest probability as compared to other tasks in the task distribution 1408.

At block 1308, the process 1300 includes generating, using the sequence of commands and the task distribution as input to a machine learning system, a probability distribution of the set of possible commands of the application. In some cases, the machine learning system can include a recurrent neural network (RNN). As illustrative examples, the machine learning system can include the TaskPST (which is not an RNN), the TaskRNN, or the command prediction RNN of the TCP model described above.

Referring to FIG. 14, the sequence of commands 1402 and the task distribution 1408 can be used to determine a probability distribution 1412 of a set of possible commands. For example, the sequence of commands 1402 and the task distribution 1408 (either output from the BTM 1404 or output from the task prediction RNN 1406) can be received as input by the command prediction RNN 1410. Using the sequence of commands 1402 and the task distribution 1408, the command prediction RNN 1410 can generate a probability distribution 1412 of the set of possible commands. To produce the probability distribution 1412, the command prediction RNN 1410 can generate input vectors by concatenating a task vector of the task distribution 1408 with each command vector representing a command from the sequence of commands 1402. For example, a first input vector can be generated by concatenating the task vector of the task distribution 1408 with a command embedding vector of a first command from the sequence of commands 1402. The command prediction RNN 1410 can then process the first input vector to generate the probability distribution 1412 of the set of possible commands. For instance, the command embedding vector of the first input vector indicates to the command prediction RNN 1410 that the first command was executed by the application, and the task distribution 1408 indicates the predicted tasks to which the first command is likely to belong (based on the probabilities within the task distribution 1408). The probabilities within the task distribution 1408 allow the command prediction RNN 1410 to remove commands that are not relevant to the one or more tasks having the highest probabilities. In some cases, the commands from the set of possible commands that are found by the command prediction RNN 1410 to be most related to the highest probability tasks in the task distribution 1408 have the highest probabilities in the probability distribution 1412.

In one illustrative example using the task distribution 1408 as input, after the InlineTextChange command in the sequence of commands 1402 is performed, the probability distribution 1412 of the set of possible commands can be determined to include, for the first task, a highest probability for a SaveSegment command and a second highest probability for a PanelCollapse command. The SaveSegment command is a command that is logged when user saves a segment, and recommending the command would thus suggest the user to save a recently created segment. The PanelCollapse command was described above, and is the next command in the sequence of commands 1402 (indicating the user selected the recommended command). For the second task, the probability distribution 1412 can be determined to include a first highest probability for a DragandDropMetric command and a second highest probability for a DragandDropDimension command. The DragAndDropMetric command is logged when a user drag-and-drops metrics into a freeform table, and recommending the command would thus suggest the user to drag-and-drop one or more metrics into a freeform table. Recommendation of the DragAndDropDimension command would suggest to the user to drag-and-drop dimensions into the freeform table. As indicated by the “ . . . ” notation, the probability distribution 1412 can include more command probabilities for each task, and can include additional tasks with command probabilities.

At block 1310, the process 1300 includes determining a command associated with the first task to recommend to the user. The command is determined from the set of possible commands based on the probability distribution of the set of possible commands. For example, a command having the highest probability from the probability distribution 1412 shown in FIG. 14 can be determined as the command. In one example using the TaskRNN (e.g., the system in FIG. 14 without using the task prediction RNN 1406), a task distribution T_{S} (for a sequence S of commands) determined using a topic model (e.g., the BTM 1404 in FIG. 14) can be concatenated with the trainable command embedding vectors cⱼ. The resulting input vectors can then be fed into the TaskRNN (e.g., the command prediction RNN 1410 in FIG. 14), which can output the probability distribution for the set of possible commands. The probability distribution can then be used to determine a predicted next command in the sequence, which can be output for recommendation to the user (e.g., as shown in FIG. 11C) at block 1312 described below. In another example, using the TCP model (e.g., the system in FIG. 14 using the task prediction RNN 1406), at each timestep t, the task distribution \hat{T}_{S}^{t} output by the first sub-module of the TCP model (e.g., the task distribution 1408 output by the task prediction RNN 1406) is concatenated with a command embedding vector cₜ of the current command in the sequence, and a resulting input vector is used by the second sub-module (the command prediction RNN 1410) of the TCP model to predict a next command cₜ₊₁ in the sequence.

In some cases, multiple commands can be determined as being associated with the first task and can be recommended to the user. For example, the top three commands that have the three highest probabilities from the probability distribution can be determined for recommendation. In some cases, multiple commands can be determined for a certain number of tasks that are determined to be related to the sequence of commands performed so far by the user. For instance, the top three commands for the top three most probable tasks can be determined for recommendation, as shown in FIG. 11C. Referring to FIG. 14 as an illustrative example, the top two next command recommendations (after the InlineTextChange command in the sequence of commands 1402) based on the probability distribution 1412 of the set of possible commands can include the SaveSegment command and the PanelCollapse command for the first task (creating a new metric/segment). The top two next command recommendations (after the InlineTextChange command in the sequence of commands 1402) can include the DragandDropMetric command and the DragandDropDimension command for the second task (freeform analysis).

At block 1312, the process 1300 includes outputting the command (or the multiple commands) as a recommendation to the application. For example, as shown the example user interfaces of FIG. 10-FIG. 12, one or more command recommendations can be displayed on a graphical interface. A user can refer to the command recommendations for continuing with or completing the ongoing task. In some examples, the commands can be output as they are determined, when a user requests recommended commands, and/or when it is determined that the user needs help, as described below.

In some cases, the process 1300 can utilize the help modeling engine 106 to determine when the user may need help. For example, the process 1300 can include processing the sequence of commands and an amount of time spent since a last command using a binary classification machine learning system, and determining an output of the binary classification machine learning system includes a class corresponding to a need for help (e.g., a binary class of 1). The process 1300 can further include determining, based on the class, that the user needs help to perform the first task. In some examples, the command is output (at block 1312) as the recommendation to the application when it is determined the user needs help. In some implementations, the process 1300 can include highlighting a help icon on a graphical interface when it is determined the user needs help. Additional information can then be presented on the graphical interface when the help icon is selected. In some cases, another indication of additional information can be displayed (e.g., a pop-up window, an overlay, and/or other visual indication) when it is determined the user needs help. In some cases, the additional information can be displayed once help is determined to be needed, without requiring selection of a help icon or other visual indication.

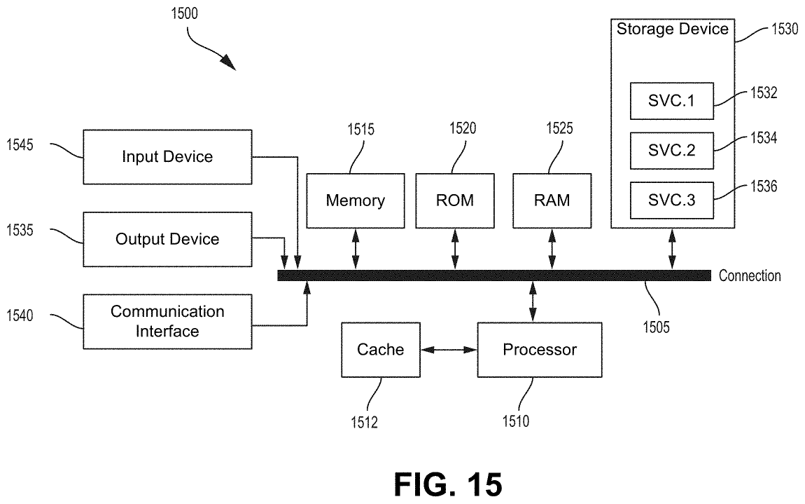

In some examples, the process 1300 may be performed by a computing device or apparatus, such as a computing device having the computing device architecture 1500 shown in FIG. 15. In one example, the process 1300 can be performed by a computing device with the computing device architecture 1500 implementing the task-aware command recommendation system 100. In some cases, the computing device or apparatus may include an input device, a task identification engine, a command recommendation engine, a help modeling engine, an output device, one or more processors, one or more microprocessors, one or more microcomputers, and/or other component(s) that is/are configured to carry out the steps of process 1300. The components of the computing device (e.g., the one or more processors, one or more microprocessors, one or more microcomputers, and/or other component) can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

Process 1300 is illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1300 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 15 illustrates an example computing device architecture 1500 of an example computing device which can implement the various techniques described herein. For example, the computing device architecture 1500 can implement the task-aware command recommendation system 100 shown in FIG. 1. The components of computing device architecture 1500 are shown in electrical communication with each other using connection 1505, such as a bus. The example computing device architecture 1500 includes a processing unit (CPU or processor) 1510 and computing device connection 1505 that couples various computing device components including computing device memory 1515, such as read only memory (ROM) 1520 and random access memory (RAM) 1525, to processor 1510.

Computing device architecture 1500 can include a cache of high-speed memory connected directly with, in close proximity to, or integrated as part of processor 1510. Computing device architecture 1500 can copy data from memory 1515 and/or the storage device 1530 to cache 1512 for quick access by processor 1510. In this way, the cache can provide a performance boost that avoids processor 1510 delays while waiting for data. These and other modules can control or be configured to control processor 1510 to perform various actions. Other computing device memory 1515 may be available for use as well. Memory 1515 can include multiple different types of memory with different performance characteristics. Processor 1510 can include any general purpose processor and a hardware or software service, such as service 1 1532, service 2 1534, and service 3 1536 stored in storage device 1530, configured to control processor 1510 as well as a special-purpose processor where software instructions are incorporated into the processor design. Processor 1510 may be a self-contained system, containing multiple cores or processors, a bus, memory controller, cache, etc. A multi-core processor may be symmetric or asymmetric.

To enable user interaction with the computing device architecture 1500, input device 1545 can represent any number of input mechanisms, such as a microphone for speech, a touch-sensitive screen for gesture or graphical input, keyboard, mouse, motion input, speech and so forth. Output device 1535 can also be one or more of a number of output mechanisms known to those of skill in the art, such as a display, projector, television, speaker device, etc. In some instances, multimodal computing devices can enable a user to provide multiple types of input to communicate with computing device architecture 1500. Communications interface 1540 can generally govern and manage the user input and computing device output. There is no restriction on operating on any particular hardware arrangement and therefore the basic features here may easily be substituted for improved hardware or firmware arrangements as they are developed.

Storage device 1530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1525, read only memory (ROM) 1520, and hybrids thereof. Storage device 1530 can include services 1532, 1534, 1536 for controlling processor 1510. Other hardware or software modules are contemplated. Storage device 1530 can be connected to the computing device connection 1505. In one aspect, a hardware module that performs a particular function can include the software component stored in a computer-readable medium in connection with the necessary hardware components, such as processor 1510, connection 1505, output device 1535, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set indicates that one member of the set or multiple members of the set satisfy the claim. For example, claim language reciting “at least one of A and B” means A, B, or A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method of determining one or more recommended commands, comprising:
obtaining a sequence of commands performed by a user of an application;
determining a task distribution based on the sequence of commands, the task distribution including an indication of whether the sequence of commands is associated with at least a first task or a second task of the application;
determining, based on the task distribution, the sequence of commands is associated with at least the first task of the application;
generating, using the sequence of commands and the task distribution as input to a machine learning system, a probability distribution of a set of possible commands;
determining a command associated with the first task to recommend to the user, the command being determined from the set of possible commands based on the probability distribution of the set of possible commands; and
outputting the command as a recommendation to the application.

2. The method of claim 1, wherein the task distribution includes at least a first probability that the sequence of commands is associated with the first task and a second probability that the sequence of commands is associated with the second task, and wherein the first task is determined to be performed by the user based on the first probability being greater than the second probability.

3. The method of claim 1, wherein the task distribution is determined based on unsupervised topic modeling using a bi-term topic model.

4. The method of claim 3, wherein an output of the bi-term topic model and the sequence of commands are used by an additional machine learning system to determine the task distribution.

5. The method of claim 1, further comprising:
generating an input vector by concatenating a task vector representing the task distribution and a command vector representing at least one command from the sequence of commands; and
processing the input vector using the machine learning system to generate the probability distribution of the set of possible commands.

6. The method of claim 1, further comprising:
processing the sequence of commands and an amount of time spent since a last command using a binary classification machine learning system;
determining an output of the binary classification machine learning system includes a class corresponding to a need for help; and
determining, based on the class, the user needs help to perform the first task.

7. The method of claim 6, wherein the command is output as the recommendation to the application when it is determined the user needs help.

8. The method of claim 6, further comprising highlighting a help icon on a graphical interface when it is determined the user needs help, wherein additional information is presented on the graphical interface when the help icon is selected.

9. The method of claim 1, wherein the machine learning system includes a recurrent neural network (RNN).

10. A system for determining one or more recommended commands, comprising:
an input device configured to obtain a sequence of commands performed by a user of an application;
a task identification engine configured to:
determine a task distribution based on the sequence of commands, the task distribution including an indication of whether the sequence of commands is associated with at least a first task or a second task of the application; and
determine, based on the task distribution, the sequence of commands is associated with at least the first task of the application;
a command recommendation engine including a machine learning system, the command recommendation engine being configured to:
generate, using the sequence of commands and the task distribution as input to the machine learning system, a probability distribution of a set of possible commands; and
determine a command associated with the first task to recommend to the user, the command being determined from the set of possible commands based on the probability distribution of the set of possible commands; and
an output device configured to output the command as a recommendation to the application.

11. The system of claim 10, wherein the task distribution includes at least a first probability that the sequence of commands is associated with the first task and a second probability that the sequence of commands is associated with the second task, and wherein the first task is determined to be performed by the user based on the first probability being greater than the second probability.

12. The system of claim 10, wherein the task identification engine includes a bi-term topic model, the bi-term topic model being configured to determine the task distribution using unsupervised topic modeling.

13. The system of claim 12, wherein the task identification engine includes an additional machine learning system, and wherein the additional machine learning system is configured to use an output of the bi-term topic model and the sequence of commands to determine the task distribution.

14. The system of claim 10, wherein the task identification engine is configured to:
generate an input vector by concatenating a task vector representing the task distribution and a command vector representing at least one command from the sequence of commands; and
process the input vector using the machine learning system to generate the probability distribution of the set of possible commands.

15. The system of claim 10, wherein the system is integrated with the application.

16. The system of claim 10, further comprising a help modeling engine configured to:
process the sequence of commands and an amount of time spent since a last command using a binary classification machine learning system;
determine an output of the binary classification machine learning system includes a class corresponding to a need for help; and
determine, based on the class, the user needs help to perform the first task.

17. The system of claim 16, wherein the output device is configured to output the command as the recommendation to the application when it is determined the user needs help.

18. The system of claim 16, wherein the help modeling engine is configured to cause a help icon to be highlighted on a graphical interface when it is determined the user needs help, wherein additional information is presented on the graphical interface when the help icon is selected.

19. A non-transitory computer-readable medium having stored thereon instructions that, when executed by one or more processors, cause the one or more processors to:
obtain a sequence of commands performed by a user of an application;
determine a task distribution based on the sequence of commands, the task distribution including an indication of whether the sequence of commands is associated with at least a first task or a second task of the application;
determine, based on the task distribution, the sequence of commands is associated with at least the first task of the application;
generate, using the sequence of commands and the task distribution as input to a machine learning system, a probability distribution of a set of possible commands;
determine a command associated with the first task to recommend to the user, the command being determined from the set of possible commands based on the probability distribution of the set of possible commands; and
output the command as a recommendation to the application.

20. The non-transitory computer-readable medium of claim 19, wherein the task distribution includes at least a first probability that the sequence of commands is associated with the first task and a second probability that the sequence of commands is associated with the second task, and wherein the first task is determined to be performed by the user based on the first probability being greater than the second probability.
